(19) United States
(12) Patent Application Publication
(10) Pub. No.: US 2010/0261613 A1
(43) Pub. Date: Oct. 14, 2010

(54) METHODS FOR INFLAMMATORY DISEASE MANAGEMENT

(76) Inventors: Michael Centola, Oklahoma City, OK (US); Philip Alex, Havre de Grace, MD (US); Nicholas Knowlton, Chocktaw, OK (US); Mark Barton Frank, Edmond, OK (US)

Correspondence Address: FENWICK & WEST LLP, SILICON VALLEY CENTER, 801 CALIFORNIA STREET, MOUNTAIN VIEW, CA, 94041, US

(21) Appl. No.: 12/669,259

(22) PCT Filed: Jul. 28, 2008
(86) PCT No.: PCT/US08/71399

§ 371 Date: Jun. 25, 2010

Related U.S. Application Data
(60) Provisional application No. 60/952,223, filed on Jul. 26, 2007.

(51) Int. Cl. C40B 30/02

(52) U.S. Cl. 506/8

(57) ABSTRACT

Quantitative expression datasets are created and used in the identification, monitoring and treatment of disease states and characterization of biological conditions. Quantitative datasets are derived from subject samples and enable evaluation of a biological condition. Such quantitative datasets may be used to provide an output score indicative of the biological state of a subject through analysis against a profile dataset.

### CROSS REFERENCE TO RELATED APPLICATIONS

This application claims the benefit of U.S. Provisional Patent Application Ser. No. 60/952,223, which is hereby incorporated by reference in its entirety for all purposes.

### STATEMENT REGARDING FEDERALLY SPONSORED RESEARCH OR DEVELOPMENT

The U.S. Government has certain rights in this invention pursuant to Grant No. P20 RR15577 SPID #1003 awarded by the National Institutes of Health.

### BACKGROUND OF THE INVENTION

1. Field of the Invention

The invention relates to methods for characterizing biological conditions by scoring quantitative datasets derived from a subject sample.

2. Description of the Related Art

The present invention relates to use of quantitative expression datasets in identification, monitoring and treatment of disease states and in characterization of a biological condition of a subject.

The prior art has used datasets derived from patients to determine the presence or absence of particular markers as diagnostic of a particular disease or condition, and in some circumstances has described the cumulative addition of scores for expression of particular markers to achieve increased accuracy or sensitivity. Information provided by tools that track disease progress and enable implementation of intervention strategies on a patient-specific basis has become an important issue in clinical medicine today not only from the aspect of efficiency of medical practice for the health care industry but for improved outcomes and benefits for the patients. Co-owned U.S. Publication No. 2006/0094056, “Method of using cytokine assays to diagnose, treat, and evaluate inflammatory and autoimmune diseases,” is directed to methods for diagnosing an inflammatory or autoimmune disease state by measuring the level of a plurality of cytokines in a patient sample and comparing those levels with pre-defined levels of cytokines found in normal, inflammatory and/or autoimmune disease states. Based on the results of the comparison, a diagnosis is made of a given inflammatory or autoimmune disease state. Different cytokines are detected depending on the disease state. For example, when the disease state is rheumatoid arthritis (RA), the cytokines can be IFN-γ, IL-1β, TNF-α, G-CSF, GM-CSF, IL-6, IL-4, IL-10, IL-13, IL-5, CCL4/MIP-1β, CCL2/MCP-1, EGF, VEGF, or IL-7; when the disease state is systemic lupus erythematosis (SLE), the cytokines can be IL-10, IL-2, IL-4, IL-6, IFN-γ, CCL2/MCP-1, CCL4/MIP-1β, CXCL8/IL-8, VEGF, EGF, or IL-17.

U.S. Pat. No. 6,555,320, “Methods and materials for evaluating rheumatoid arthritis,” describes classifying rheumatoid arthritis by determining the level of one or more cytokines within a sample from a patient and comparing the cytokine level to one or more reference levels. The one or more cytokines is selected from the group consisting of IL-1β, IL-4, IL-10, IFN-γ, TNF-α, and TGF-β.

What is needed are improved methods for diagnosis, classification, prognosis, and making treatment decisions based on expression levels of sets of markers. The present invention provides for these and other advantages, as described below.

### SUMMARY OF THE INVENTION

In a first embodiment, there is provided a method, for scoring a sample acquired from a mammalian subject. The method includes obtaining a dataset that includes quantitative data associated with dataset members IL-4, IL-6, IL-8, IL-13, MCP-1, and TNF-α; analyzing the dataset against a cytokine profile dataset to produce a first score for the sample; and outputting a first score for the sample.

In certain embodiments, the analyzing step comprises use of a predictive model.

In yet other embodiments, the predictive model is developed using at least one of: logistic regression, discriminate function analysis (DFA), classification and regression tree (CART), principal component analysis (PCA), Meta Learners, Boosted CART, Random Forests, support vector machines (SVM), and bootstrap aggregating (bagging).

In yet other embodiments, the invention includes predicting a quantitative clinical data point selected from the group consisting of: DAS, DAS 28, HAQ, mHAQ, MDHAQ, physician global assessment VAS, patient global assessment VAS, pain VAS, fatigue VAS, Overall VAS, sleep VAS, SDAI, CDAI, ACR20, ACR50, ACR70, sharp score, van der Heijde modified sharp score, mTSS, and Larson score, are predicted.

In yet other embodiments the invention provides for a method of categorizing the sample according to the predictive model. This embodiment includes the categorizations a rheumatoid arthritic disease categorization, a healthy categorization, a therapy-responsive categorization, and a therapy non-responsive categorization. In various embodiments, the categorization is at least 60% accurate, at least 70% accurate, at least 80% accurate or at least 90% accurate.

In another embodiment, a therapeutic regimen is selected based on the score.

In another related embodiment, the score is compared to a second score determined for a second sample obtained from the mammalian subject. In one embodiment the comparison is indicative of a response to treatment. In another embodiment the comparison is indicative of a change in disease activity.

In one embodiment, the quantitative data associated with at least one dataset member is determined by substitution of quantitative data corresponding to a marker known to have expression highly correlated with the at least one dataset member. The correlation coefficient for the substitution may be greater than 0.5 for the at least one dataset member and the marker known to have expression highly correlated with the at least one dataset member, or greater than 0.7, or greater than 0.9.

In another related embodiment, the dataset further comprises quantitative data associated with IL-1β. In another related embodiment, the dataset further comprises quantitative data associated with IL-1β, IL-2, IL-12, IL-15, IL-17, IL-5, and IL-10. In another related embodiment, the dataset further comprises quantitative data associated with IL-1β, IL-2, IL-12, GM-CSF, G-CSF, IL-7, IL-17, IL-5, IL-10, IL-13, and MIP-1β. In another related embodiment, the dataset further comprises quantitative data associated with MIP-1β, G-CSF, IL-17, IL-12, IL-7, GM-CSF, IL-1β, IL-2, IL-5, and IL-10. In another related embodiment, the dataset further comprises quantitative data associated with IL-2, GM-CSF, IL-7, IL-17, and G-CSF. In another related embodiment, the dataset further comprises quantitative data associated with IL-12, IL-1β, IL-10, IL-5, MIP-1β, IL-2, GM-CSF, IL-7, and IL-17. In another related embodiment, the dataset further comprises quantitative data associated with IL-1β, IL-2, IL-5, IL-7, IL-10, IL-12, IL-15, IL-17, IFN-α, IFN-γ, GM-CSF, MIP-1α, MIP-1β, IP-10, Eotaxin, and IL-1 receptor antagonist.

In another related embodiment, the dataset includes values determined using a process that includes a protein binding step. In certain embodiments, the protein is an antibody.

In certain embodiments, univariate marker models are used, and in other embodiments, multivariate marker models are used.

### BRIEF DESCRIPTION OF THE DRAWINGS

These and other features, aspects, and advantages of the present invention will become better understood with regard to the following description, and accompanying drawings, where:

FIG. 1A shows a pair-wise comparison of serum cellular cytokine profiles between RA patients and unaffected controls.

FIG. 1B shows a pair-wise comparison of serum humoral cytokine profiles between RA patients and unaffected controls.

FIG. 1C shows a pair-wise comparison of serum chemokine profiles between RA patients and unaffected controls.

FIG. 2A shows correlational clustering using correlational cluster analysis of serum cytokine profiles as a cluster mosaic in which color mapping was used to represent correlation levels.

FIG. 2B shows correlational clustering of individual serum cytokine profiles of the study subjects from each of the three clusters in FIG. 2A.

FIG. 3 shows ROC curves applied to a real-world RA cohort where the sensitivity of disease activity detection was 82%, 50%, and 9% for the CAI, CRP, and ESR, respectively.

FIG. 4A shows changes in serum levels of cytokines that decreased following MTX treatment in both responders and nonresponders.

FIG. 4B shows cytokine levels that remained unchanged or increased following MTX treatment in both responders and nonresponders.

FIG. 4C shows efficacy measures of clinical response, HAQ and DAS28 scores, for both responders and nonresponders during MTX treatment.

FIG. 5 shows an application of the Cytokine Activity Index (CAI) in which CAI values decreased towards normalcy during treatment in responders, but remained principally in the range of patients prior to treatment in non-responders.

FIG. 6A shows averages of serum cytokine levels in patients prior to and after 7 months of therapy with TNF-α-inhibitor/MTX treatment.

FIG. 6B shows efficacy measures of clinical response, HAQ and DAS28 scores, during TNF-α-inhibitor/MTX treatment.

FIG. 7A shows the tracking of disease activity changes with the inflammatory cytokine monitoring panel (ICMP) by measuring the serum levels of T cell, B cell, and erosive cytokines in an RA patient with active (HAQ=3.8), erosive disease during infliximab/MTX treatment (black bars) relative to control ranges (grey bars).

FIG. 7B uses ICMP to show that CAI levels were highly elevated in the patient described in FIG. 7A relative to control ranges during infliximab/MTX treatment.

FIG. 8A includes tables showing an original set of terms including AuC value, intercept value, and beta parameters for the four markers used (IL-1β, IL-6, IL-7, IP-10) (top box), and substitution of GM-CSF, IFN-γ, IL-2, IL-10, and IL-15 for IL-1β (bottom box) into a logistic regression equation in a manner that maintains predictive accuracy.

FIG. 8B includes tables showing substitution of Eotaxin, IFN-γ, IL-1 RA, IL-2, IL-12, and IL-15 for IP-10 (top box), and substitution of IFN-γ, IL-2, IL-4, IL-13, and MIP-1β for IL-7 (bottom box) into a logistic regression equation in a manner that maintains predictive accuracy.

FIG. 8C includes tables showing substitution of IFN-α, IFN-γ, IL-2, IL-12, and IL-15 for IL-6 into a logistic regression equation in a manner that maintains predictive accuracy.

### DETAILED DESCRIPTION

Unless otherwise defined, all technical and scientific terms used herein have the same meaning as commonly understood by one of ordinary skill in the art to which this invention belongs. Although methods and materials similar or equivalent to those described herein can be used in the practice and testing of the present invention, suitable methods and materials are described below.

Other features and advantages of the invention will be apparent from the following detailed description, the drawings, and from the claims.

### DEFINITIONS

Terms used in the claims and specification are defined as set forth below unless otherwise specified.

To “analyze” includes determining a set of values associated with a sample by measurement of constituent expression levels in the sample and comparing the levels against constituent levels in a sample or set of samples from the same subject or other subject(s).

The term “antibody” refers to any immunoglobulin-like molecule that reversibly binds to another with the required selectivity. Thus, the term includes any such molecule that is capable of selectively binding to a marker of the invention. The term includes an immunoglobulin molecule capable of binding an epitope present on an antigen. The term is intended to encompasses not only intact immunoglobulin molecules such as monoclonal and polyclonal antibodies, but also bi-specific antibodies, humanized antibodies, chimeric antibodies, anti-idiopathic (anti-ID) antibodies, single-chain antibodies, Fab fragments, F(ab′) fragments, fusion proteins antibody fragment, immunoglobulin fragment, Fᵥ, single chain (sc) Fᵥ, and chimeras comprising an immunoglobulin sequence and any modifications of the foregoing that comprise an antigen recognition site of the required selectivity.

A “clinical datapoint” is a value or set of values representing, for example, disease severity and resulting from evaluation of a sample (or population of samples) under a determined condition in a subject. One of ordinary skill in the art will recognize that the clinical datapoint may be, for example, one or more of the following types: DAS, DAS 28, HAQ, mHAQ, MDHAQ, physician global assessment VAS, patient global assessment VAS, pain VAS, fatigue VAS, Overall VAS, sleep VAS, SDAI, CDAI, ACR20, ACR50, ACR70, sharp score, van der Heijde modified sharp score, mTSS, or Larson score.

A “dataset” is a set of numerical values resulting from evaluation of a sample (or population of samples) under a desired condition. The values of the dataset may be obtained, for example, by experimentally obtaining measures from a sample and constructing a dataset from the measurements to obtain the dataset, or alternatively, obtaining a dataset from a service provider such as a laboratory, or from a database or a server on which the dataset has been stored.

A “mammalian subject” is a cell, tissue, or organism, human or non-human, whether in vivo, ex vivo or in vitro, under observation from a mammal. When we refer to analyzing a subject based on a sample from the subject, we include using blood or other tissue sample from a subject to evaluate the subject's condition; but we also include, for example, using a blood sample itself as the subject to evaluate, for example, the effect of therapy or an agent upon the sample.

The term “mammalian” as used herein includes both humans and non-humans and include but is not limited to humans, non-human primates, canines, felines, murines, bovines, equines, and porcines.

A “cytokine profile dataset” is a set of numerical values associated with levels of, e.g., cytokines, chemokines, and/or growth factors, resulting from evaluation of a sample (or population of samples) under a desired condition that is used for analyzing purposes. The desired condition may be, for example, the condition of a subject (or population of subjects) before exposure to an agent or in the presence of an untreated disease or in the absence of a disease. Alternatively, or in addition, the desired condition may be health of a subject or a population of subjects. Alternatively, or in addition, the desired condition may be that associated with a population subjects selected on the basis of at least one of age group, gender, ethnicity, geographic location, diet, medical disorder, clinical indicator, medication, physical activity, body mass, and environmental exposure.

A “predictive model” is a mathematical construct developed using an algorithm or algorithms for grouping sets of data to allow discrimination of the grouped data. As will be apparent to one of ordinary skill in the art, a predictive model can be developed using logistic regression, DFA, CART, SVM, bagging, principal component analysis (PCA), Meta Learners, Boosted CART, and Random Forests.

The term “predicting” refers to generating a value for a datapoint without performing the clinical diagnostic procedures normally required to produce the datapoint.

A “response to treatment” includes a response to all interventions whether biological, chemical, physical, or a combination of the foregoing, intended to sustain or alter the condition of a subject.

A “sample” from a subject may include a single cell or multiple cells or fragments of cells or an aliquot of body fluid, taken from the subject, by means including venipuncture, excretion, ejaculation, massage, biopsy, needle aspirate, lavage sample, scraping, surgical incision or intervention or other means known in the art.

A “score” is a value or set of values selected to discriminate a subject's condition based on, for example, a measured amount of sample constituent from the subject. In certain embodiments the score can be derived from a single constituent; while in other embodiments the score is derived from multiple constituents.

A “therapeutic regimen” includes all interventions whether biological, chemical, physical, or combination of these, intended to sustain or alter the condition of a subject.

Abbreviations

Abbreviations used in this application include the following: Interleukin (IL), Interferon (IFN), Tumor Necrosis Factor (TNF), Interferon-inducible Protein 10 (IP-10), Monocyte Chemoattractant Protein (MCP), Macrophage Inflammatory Protein (MIP), Regulated upon Activation, Normal T-cell Expressed, and Secreted (RANTES), Granulocyte-Macrophage Colony Stimulating Factor (GM-CSF), Granulocyte Colony Stimulating Factor (G-CSF), Rheumatoid Arthritis (RA), Inflammatory Cytokine Monitoring Panel (ICMP), Cytokine Activity Index (CAI), Methotrexate (MTX), Disease Modifying Anti-Rheumatic Drug (DMARD), Discriminant Function Analysis (DFA), Receiver Operator Characteristics (ROC), C-Reactive Protein (CRP), Rheumatoid Factor (RF), Erythrocyte Sedimentation Rate (ESR), Polymerase Chain Reaction (PCR), Classification and Regression Tree (CART), Support Vector Machines (SVM), and bootstrap aggregating (bagging), Health Assessment Questionnaire (HAQ), Modified Health Assessment Questionnaire (mHAQ), MultiDimensional Health Assessment Questionnaire (MDHAQ), visual analogue scale (VAS), Disease Activity Score (DAS), Modified Disease Activity Score (DAS28), Simplified Disease Activity Index (SDAI), Clinical Disease Activity Index (CDAI), American of Rheumatology Response Criteria (ACR20, ACR50, ACR70).

It must be noted that, as used in the specification and the appended claims, the singular forms “a,” “an,” and “the” include plural referents unless the context clearly dictates otherwise.

### METHODS OF THE INVENTION

### Patients and Controls

The study population consisted of patients with active RA who fulfilled the ACR 1987 criteria (Arnett F C, Edworthy S M, Bloch D A, et al., The American Rheumatism Association 1987 revised criteria for the classification of rheumatoid arthritis, Arthritis Rheum., 1988; 31(3):315-24.). To ensure that only early patients with high risk prognosis for erosive disease were enrolled, required criteria included: recent-onset disease (duration <3 years), MTX-naïve patients, at least 6 swollen joints and at least 6 tender joints (based on a 28-joint count), at least 3 radiographic bony erosions or a positive serum test for rheumatoid factor, and an erythrocyte sedimentation rate of at least 28 mm per hour or a serum C-reactive protein concentration of at least 20 mg per liter. Stable doses of nonsteroidal anti-inflammatory drugs and prednisone (less/equal 10 mg daily) were allowed. Laboratory assessments were monitored both before and during MTX treatment and included routine hematology, a comprehensive metabolic panel, ESR, CRP, Antinuclear Antibody (ANA) and Rheumatoid Factor (RF). The Stanford Health Assessment Questionnaire (HAQ) (Fries J F, Spitz P, Kraines R K, Holman H., Measurement of patient outcome in arthritis, Arthritis Rheum., 1980; 23: 137-45.) was the primary outcome measure of efficacy and the Disease Activity Score (DAS28) (van der Heijde D M, van't H of M, van Riel P L, van de Putte L B., Development of a disease activity score based on judgment in clinical practice by rheumatologists, J. Rheumatol., 1993; 20, 579-81.) was calculated at each time point as secondary measures of efficacy. Other measures of outcome efficacy used included: VAS Overall, VAS fatigue, VAS pain, and VAS sleep. The cohort studied also included normal age and sex matched healthy controls. The study was approved by the Institutional Review Boards of the University of Oklahoma Health Sciences Center and the Oklahoma Medical Research Foundation, and blood samples were obtained from both patients and controls after informed consent and treated anonymously throughout the analysis.

### Serum Samples

Blood was collected in endotoxin-free silicone coated tubes without additive. The blood samples were allowed to clot at room temperature for 30 min before centrifugation (3000 r.p.m., 4° C., 10 min) and the serum was removed and stored at −80° C. until analyzed.

### Measurement of a Sample Constituent

For measuring the amount of a protein constituent in a sample, we have used multiplex profiling and bioinformatics analysis of cytokine, chemokine, and growth factor levels (collectively referred to in this specification as “cytokines”) using Luminex technology (Luminex, Inc.) which is currently considered a cutting-edge biomedical research method allowing the simultaneous measurement of dozens of cytokines in a small volume of fluid. Over the past 3 years, we have extensively optimized this fluorescent microparticle immunosandwich analysis technology through addition of robotic preparation procedures, substitution of more pure and brighter detection reagents, and modification of processing methods. The optimized methodology allows detection of cytokine levels at ˜20 times lower concentrations on average than any other existing multiplex assay, a level of sensitivity necessary to detect disease activity in some patients and to readily distinguish this activity from unaffected controls. In addition, the application of robotic liquid handling and standardized protocols for assay performance has resulted in improved assay reproducibility by reducing human manipulation, sufficient to detect and monitor disease activity in patients and to obtain CAP (College of American Pathologists) and CLIA (Clinical Laboratory Improvement Amendments) approval. The methods have been engineered for high-throughput analysis allowing for the routine examination of 250 samples per week, which can be readily expanded to meet the needs of a diagnostics facility.

Briefly, beads with defined spectral properties were conjugated to analyte-specific capture antibodies, and samples (including standards of known analyte concentration, control specimens, and unknowns) were pipetted into the wells of a filter bottom microplate, and incubated for 2 hours. During this first incubation, analytes bind to the capture antibodies on the beads. After washing, biotinylated detection antibodies were added and incubated with the beads for 1 hour. During this time, the biotinylated detection antibodies recognize epitopes and bind to the immobilized analytes. After removal of excess biotinylated detector antibodies, streptavidin conjugated to the fluorescent protein R-Phycoerythrin (Streptavidin-RPE) was added and incubated with the beads for 30 minutes. During this final incubation, the Streptavidin-RPE binds to the biotinylated detector antibodies associated with the immune complexes on the beads, forming four-member solid phase sandwiches. After washing to remove unbound Streptavidin-RPE, the beads were analyzed with the Luminex 100™ instrument. By monitoring the spectral properties of the beads and the amount of fluorescence associated with R-Phycoerythrin, the instrument measures the concentration of analytes.

### Modeling Methods

Logistic Regression is the traditional analysis of choice for dichotomous variables, e.g., treatment 1 vs. treatment 2. It has the ability to model both linear and non-linear aspects of the variables and provides easily interpretable odds ratios.

Discriminate Analysis (DFA) uses a set of analytes (roots) to discriminate between two or more naturally occurring groups. DFA is used to test analytes that were significantly different between groups at baseline levels. A forward step-wise DFA can be used to select a set of analytes that maximally discriminate among the groups studied. Specifically, at each step all variables can be reviewed to determine which will maximally discriminate among groups. This is then included in a discriminative function, denoted a root, which is an equation consisting of a linear combination of changes in analytes used for the prediction of group membership. The discriminatory potential of the final equation can be observed as a line plot of the root values obtained for each group. This approach identifies groups of analytes whose changes in concentration levels can be used to delineate profiles, diagnose and assess therapeutic efficacy. The DFA model can also create an arbitrary score by which new subjects can be classified as either “healthy” or “diseased.” To facilitate the use of this score for the medical community the score can be rescaled so a value of 0 indicates a healthy individual and scores greater than 0 indicate increasing disease activity.

Classification and Regression Trees (CART) perform logical splits (if/then) of the data to create a decision tree. Each end point on the tree decides observation classification. CART results are easily interpretable; one follows a series of if/then tree branches until a classification results.

Support Vector Machines (SVM) classify objects into two or more classes. Examples of classes include sets of treatment alternatives, sets of diagnostic alternatives, or sets of prognostic alternatives. Each object is assigned to a class based on its similarity to (or distance from) objects in the training data set in which the correct class assignment of each object is known. The measure of similarity of a new object to the known objects is determined using support vectors, which define a region in a potentially high dimensional space (>R6).

Bootstrap AGGregatING or “Bagging” comes from recent advances in statistical learning. The process of bagging is computationally simple. First, thousands of bootstrapped re-samples of data are created, effectively providing thousands of datasets. Each of these new datasets is fed to a given model. Then, the class of every new observation is predicted by the 1000+ classification models created in step 1. The final class decision is based upon a majority vote of the classification trees, i.e., 33%+ for a 3 class system. For example, if a logistical regression is bagged 1000 times there will be 1000 logistical models and each will give a probability of belonging to class 1 or 2. A final classification call is determined by counting the number of times a new observation is classified into a given group and taking the majority classification.

### Biometric Multiplex Assay

A multiplex sandwich immunoassay protein array system (Bio-Rad Inc.), which contains dyed microspheres conjugated with a monoclonal antibody specific for a target protein was used. Serum samples were thawed and run in duplicates. Antibody-coupled beads were incubated with the serum sample (antigen) after which they were incubated with biotinylated detection antibody before finally being incubated with streptavidin-phycoerythrin. A broad sensitivity range of standards (Bio-Rad, Inc) ranging from 1.95-32000 pg/ml were used to help enable the quantitation of a wide dynamic range of cytokine concentrations while still providing high sensitivity. Bound molecules were then read by the Bio-Plex array reader which uses Luminex fluorescent-bead-based technology with a flow-based dual laser detector with real time digital signal processing to facilitate the analysis of up to 100 different families of color-coded polystyrene beads and allow multiple measurements of the sample ensuing in the effective quantitation of cytokines

### Statistical Analysis

Analyte concentrations were quantified by fitting using a calibration or standard curve. A 5-parameter logistic regression analysis was performed to derive an equation that allowed concentrations of unknown samples to be predicted. Statistical differences in measured values were assessed by a Wilcoxon rank-sums test. P values less than 0.05 were considered statistically significant.

### Correlational Clustering

Commonality among patient profiles was determined using correlational cluster analysis which is based on calculation of a value, denoted “connectivity,” defined as the number of patients whose cytokine expression levels and their changes with respect to time correlated with that observed in another individual (Jorgensen E D, Dozmorov I, Frank M B, Centola M, Albino A P., Global gene expression analysis of human bronchial epithelial cells treated with tobacco condensates, Cell Cycle 2004; 3(9):1154-68.; Dozmorov I, Saban M R, Knowlton N, Centola M, Saban R., Connective molecular pathways of experimental bladder inflammation., Physiol Genomics 2003; 15(3):209-22.; Alex P, Dozmorov I, Chappell C, et al., Novel approaches to identify distinct immunopathogenic biomarkers in patients with rheumatoid arthritis, Arthritis And Rheumatism 2004; 50 (9): S351-S351 Suppl.). Samples were considered related if the Pearson correlation coefficient (ρ) was greater than 0.7. Statistical significance was determined by bootstrapping the dataset; therefore, the resampled (empirical) distribution was used to select the correlation (ρ), above which casual associations have p<0.05 chance of occurring. Once created, the clusters were resorted by connectivity and cluster membership. Then a mosaic representation of the correlation coefficients was graphed using SigmaPlot v 8.02a (SPSS Inc., Chicago, Ill.).

### EXAMPLES

Below are examples of specific embodiments for carrying out the present invention. The examples are offered for illustrative purposes only, and are not intended to limit the scope of the present invention in any way. Efforts have been made to ensure accuracy with respect to numbers used (e.g., amounts, temperatures, etc.), but some experimental error and deviation should, of course, be allowed for.

The practice of the present invention will employ, unless otherwise indicated, conventional methods of protein chemistry, biochemistry, recombinant DNA techniques and pharmacology, within the skill of the art. Such techniques are explained fully in the literature. See, e.g., T. E. Creighton, Proteins: Structures and Molecular Properties (W.H. Freeman and Company, 1993); A. L. Lehninger, Biochemistry (Worth Publishers, Inc., current addition); Sambrook, et al., Molecular Cloning: A Laboratory Manual (2nd Edition, 1989); Methods In Enzymology (S. Colowick and N. Kaplan eds., Academic Press, Inc.); Remington's Pharmaceutical Sciences, 18th Edition (Easton, Pa.: Mack Publishing Company, 1990); Carey and Sundberg Advanced Organic Chemistry 3^{rd} Ed. (Plenum Press) Vols A and B (1992).

### Example 1

### Pair-Wise Comparison of Serum Cytokine Profiles Between RA Patients and Unaffected Controls

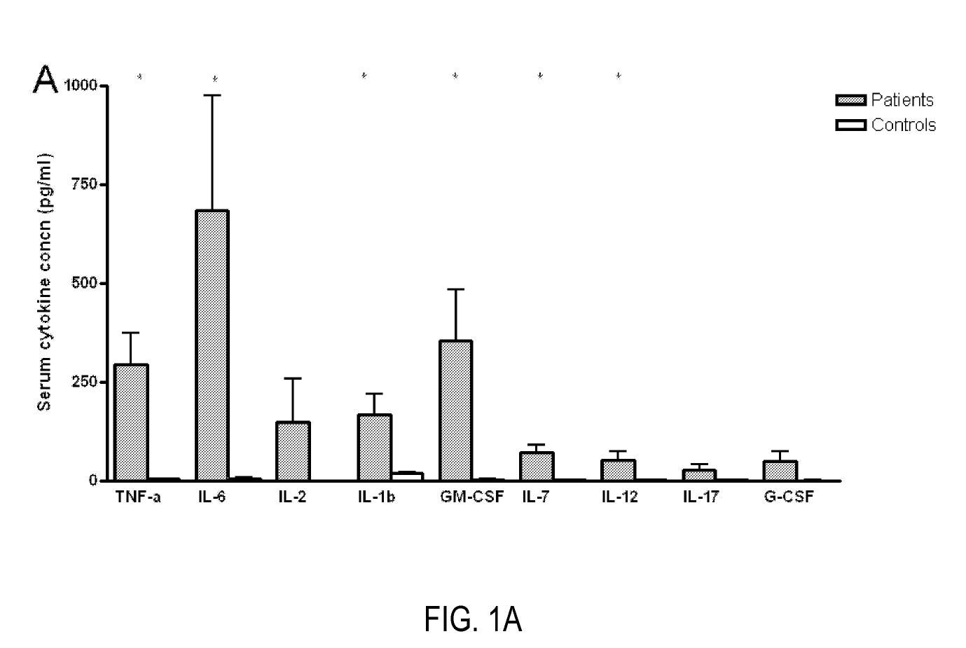

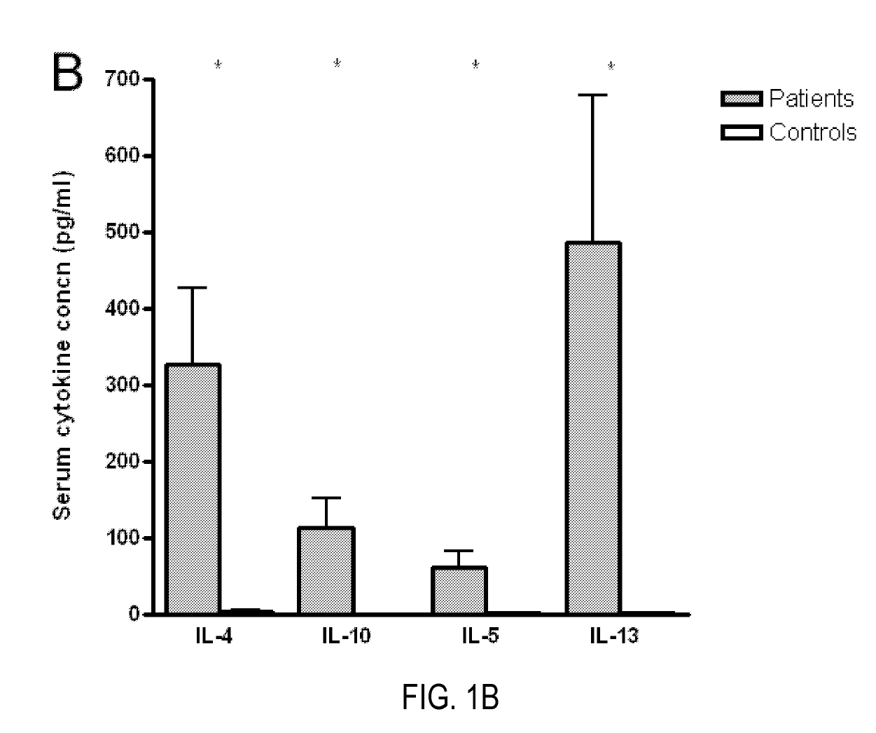

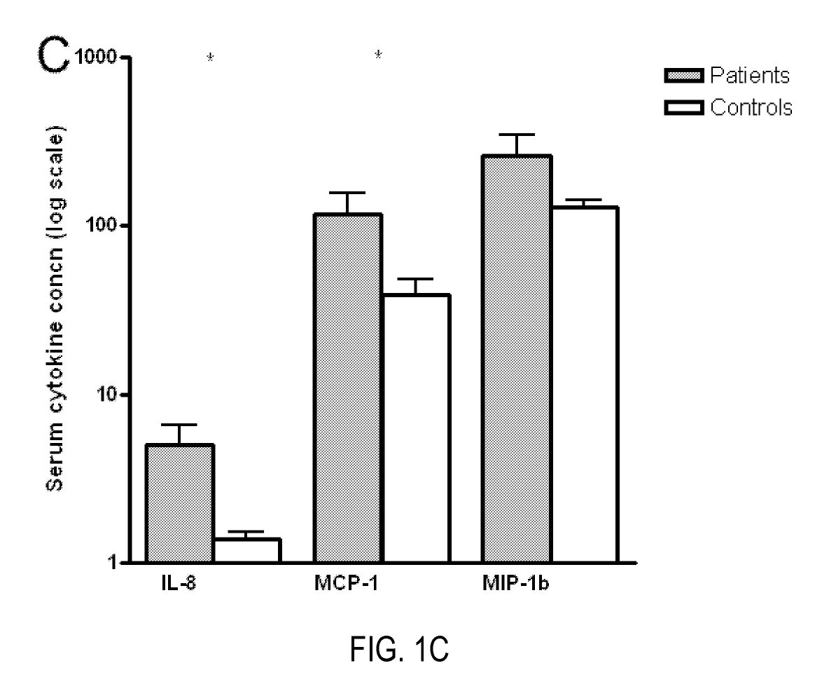

The cytokines assayed in the pair-wise comparison include key modulators of inflammation, cellular and humoral immunity, and leukocyte trafficking The levels of 16 cytokines were assessed in the serum of 18 early DMARD naïve RA patients fulfilling ACR criteria and 18 age and sex matched unaffected controls. Ten of the 16 cytokines were significantly upregulated in the peripheral blood of RA patients on average when compared to healthy controls (FIG. 1A-C).

Significantly upregulated cytokines include: TNF-α (p=0.0009), IL-6 (p=0.026), IL-1β (p=0.0095), GM-CSF (p=0.009), IL-4 (p=0.002), IL-10 (p=0.007), IL-5 (p=0.005), IL-13 (p=0.017), IL-8 (p=0.02), MCP-1 (p=0.049). These cytokines fall into several broad functional classes including: pro-cell-mediated immunity (e.g. IL-1β, IL-2, IL-7, IL-12, IL-17, TNF-α, G-CSF, GM-CSF), pro-humoral immunity (e.g. IL-4, IL-5, IL-6, IL-10, IL-13), and chemokines (e.g. MCP-1, MIP-1β and IL-8), suggesting that early RA involves the complex interplay of adaptive and innate immunity. No cytokines were decreased in this RA cohort relative to the cohort of unaffected individuals.

These findings support the idea that RA is a complex immune/inflammatory disorder involving dysregulation of cellular, humoral and innate immunity with a significant systemic signature readily distinguishable from healthy controls.

FIG. 1A shows a pair-wise comparison of serum cellular cytokine profiles between RA patients and unaffected controls.

FIG. 1B shows a pair-wise comparison of serum humoral cytokine profiles between RA patients and unaffected controls.

FIG. 1C shows a pair-wise comparison of serum chemokine profiles between RA patients and unaffected controls.

### Example 2

### Serum Cytokine Profiles Differentiate Patients by Relative Levels Disease Activity

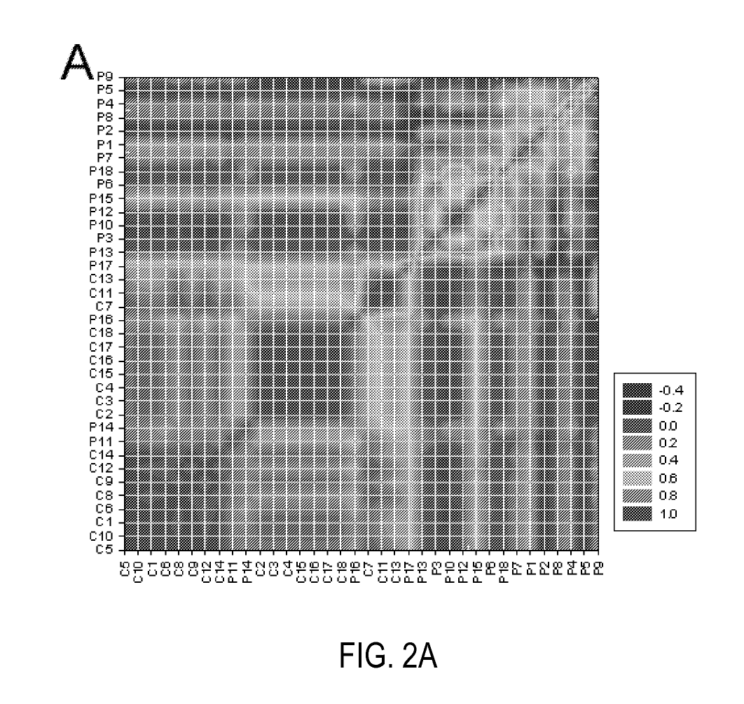

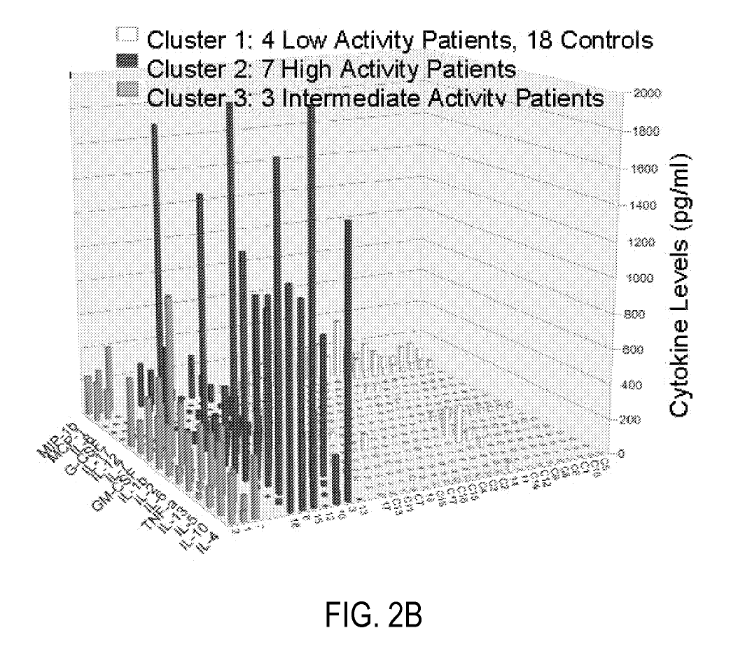

The Inflammatory Cytokine Monitoring Panel (ICMP) is a technology developed by the inventors that measures and monitors the levels of regulatory cytokines in patient sera. Correlational clustering, an unsupervised clustering method, was used to identify disease subsets based on grouping individuals with similar cytokine levels measured with the ICMP. This multivariate method has an advantage relative to a paired analysis, which flags individual cytokines. In this analysis, similarity of cytokine regulation, including relative levels and statistical dependence were utilized for class distinction, not simply differences in single cytokine levels. This facilitates both identification and subsequent functional characterization of disease subsets and the mediators that drive disease activity within each subset. The results of these analyses were represented in graphical outputs, denoted mosaics (see FIG. 2).

Three major clusters that contain the majority of patients are shown in FIG. 2A. Clinical, autoantibody, and cytokine profile characteristics of the individuals within major clusters were compared. Interestingly, the principal difference among these clusters was determined to be the relative levels of cytokines as opposed to gross changes in the classes of cytokines (FIG. 2B). Moreover, cytokine levels correlate with disease activity. This indicates that the cohort was not made up of functionally-distinct disease subsets; it was made up of patients with differences in disease severity.

Cluster 1 was comprised of 4 RA patients with serum cytokine levels similar to controls and is the only patient cluster that also contained unaffected controls. Patients in this cluster had the lowest cytokine profiles overall within the cohort and, correspondingly, the lowest values of several laboratory and disease activity parameters including CRP, RF, and HAQ (FIG. 2B).

Cluster 2 contained 7 RA patients, all of whom had the most significant elevations in cytokine levels in the cohort (FIG. 2B). Correlation with laboratory and disease activity parameters was also observed, as the patients in this cluster had the highest HAQ and CRP values.

Cluster 3 contained 3 patients with intermediate levels of both clinical and laboratory indices (HAQ, CRP, and ESR) and cytokines relative to patients in Cluster 1 and Cluster 2 (FIG. 2A-B).

These results demonstrate that serum cytokines correlate with disease activity. The ICMP therefore provides a way to identify patients with aggressive disease who are likely to benefit from combination therapy.

FIG. 2A shows correlational clustering using correlational cluster analysis of serum cytokine profiles as a cluster mosaic in which color mapping was used to represent correlation levels.

FIG. 2B shows correlational clustering of individual serum cytokine profiles of the study subjects from each of the three clusters in FIG. 2A.

### Example 3

### Relative Power of the Cytokine Activity Index (CAI) to Detect Disease Activity in a Larger and More Clinically Relevant Cohort

To be useful, biomarker-based tests must have applicability to real-world RA patients. Cytokine values can be combined into a single value using multivariate algorithms. These mathematical combinations of cytokine values can be used to assess changes in overall cytokine activity in a given patient. If the results of an algorithm are highly correlated to disease activity then the algorithm has the potential to provide a quantitative measure of disease activity and therapeutic response.

Discriminant Function Analysis (DFA) is a multivariate class distinction method that creates a weighted linear combination of variables that optimally defines group membership. We created a multivariate cytokine algorithm using DFA that best discriminated RA patients from controls. The result algorithm was denoted a “Cytokine Activity Index” (CAI).

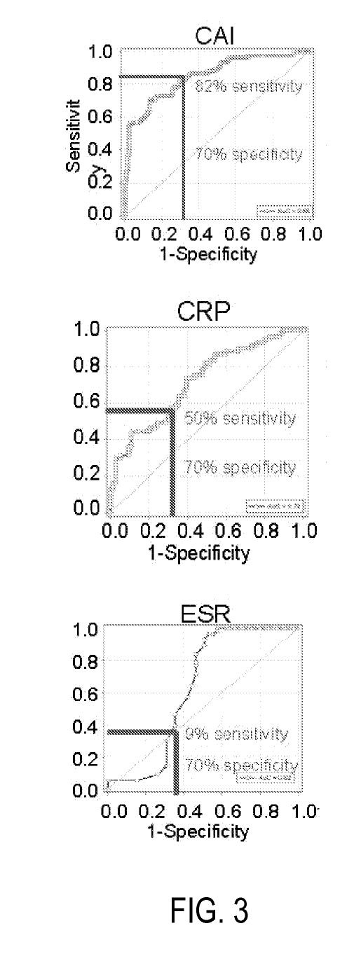

We then tested the associations between the CAI and clinical findings. Most clinical studies of RA are limited to patients fulfilling ACR criteria and commonly only include patients with active disease. These “clinical study” cohorts represent a small fraction of the RA patient population seen in practice and real world cohorts are more diverse than most clinical study cohorts. To assess the relative power of the CAI in a real-world patient population, data from patients diagnosed and treated for RA by clinicians in practice were assessed. The relative sensitivity and specificity of the CAI, CRP, and ESR in regards to detection of disease activity was assessed in a cohort of 74 physician-defined RA patients and 127 healthy controls using Receiver Operator Characteristics (ROC) analysis. The statistical power of the CAI to detect disease activity was greater than CRP or ESR (FIG. 3). These findings indicate that the CAI is a more powerful test of disease activity than ESR and CRP and is applicable to RA patients encountered in clinical practice.

FIG. 3 shows ROC curves applied to a real-world RA cohort where the sensitivity of disease activity detection was 82%, 50%, and 9% for the CAI, CRP, and ESR, respectively.

### Example 4

### Quantitative Assessment of Clinical Response to MTX Treatment Using Cytokine-Based Biomarkers

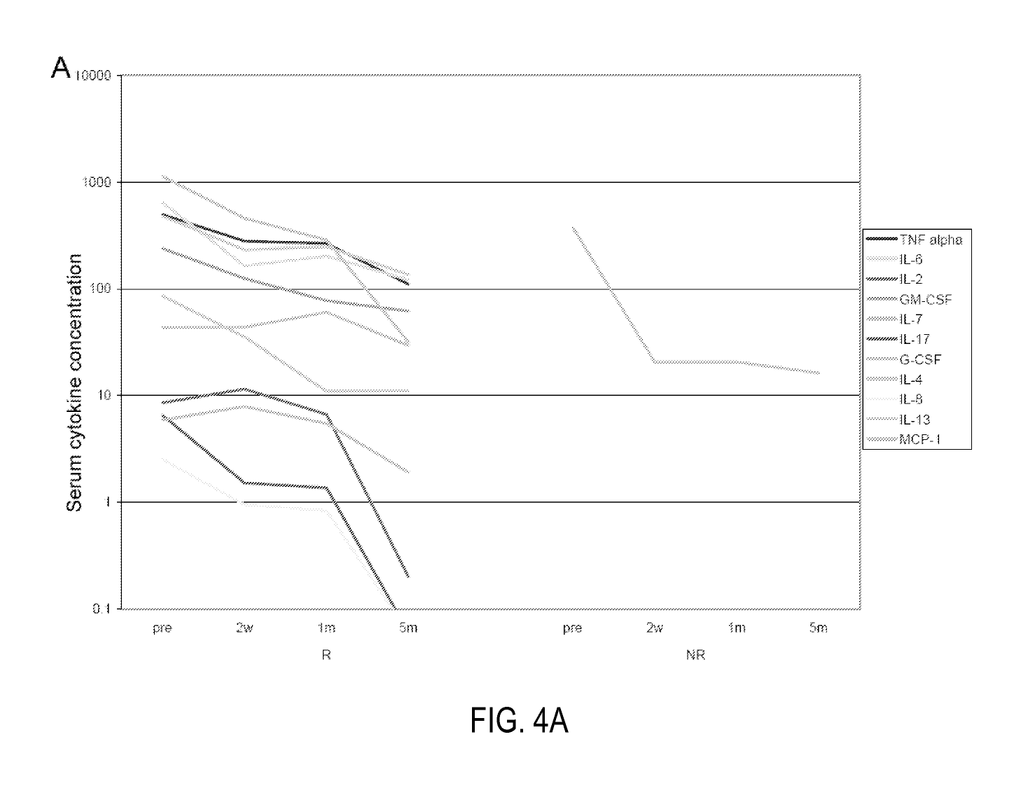

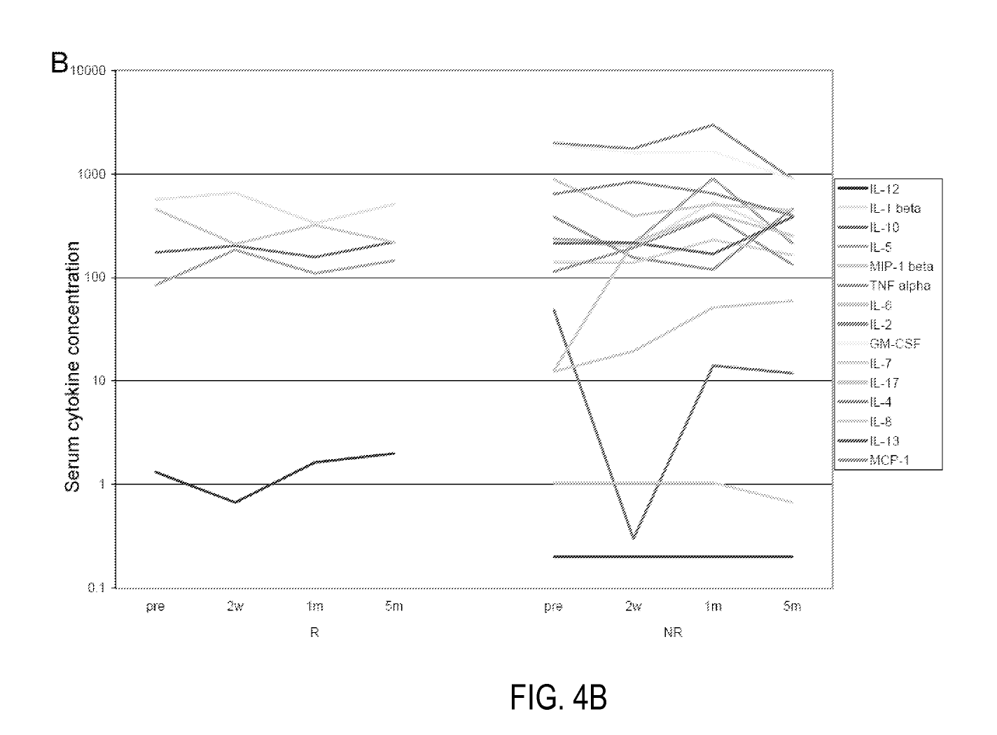

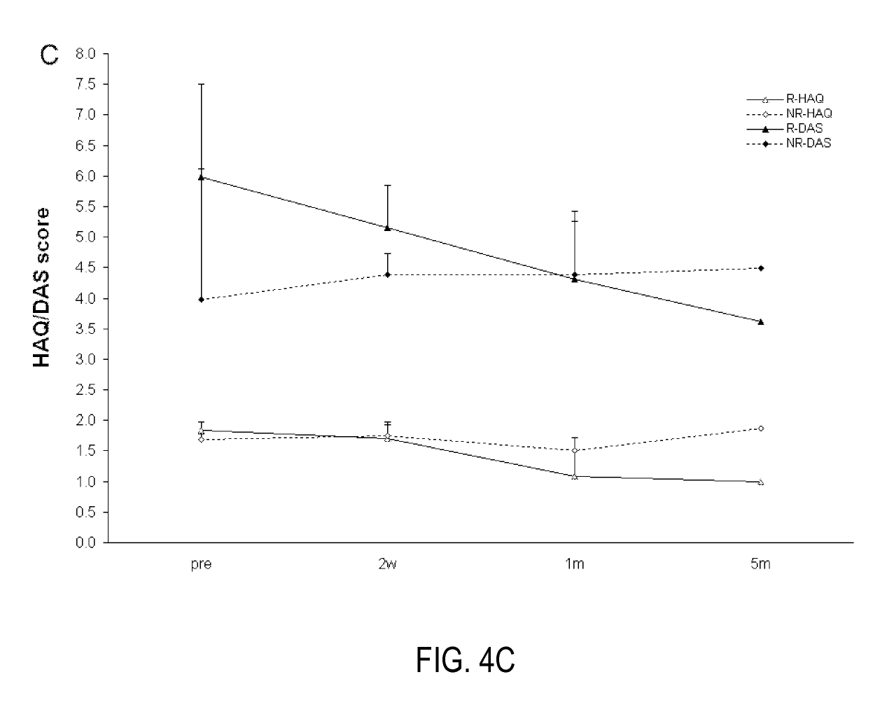

Anti-cytokine therapy functions by modulating cytokine activity. Other RA therapy, including MTX therapy also modulates cytokines. To determine if response to MTX treatment could be assessed using the ICMP, 16 serum cytokines levels were measured prospectively in the 18 ACR-defined RA patients prior to and during treatment, as were clinical assessments and laboratory values. Responders and nonresponders to MTX were identified as those patients with a change in DAS 28 score of 1.2 units after at least 8 weeks of treatment. When pre-treatment serum cytokine levels were compared to post-treatment levels at the end of therapy, MTX-responsive patients were clearly distinguishable from non-responsive patients (FIG. 4A-C). Responders had statistically significant reductions in 11 cytokines (i.e., TNF-α, IL-6, IL-2, GM-CSF, IL-7, IL-17, G-CSF, IL-4, IL-8, MCP-1, and IL-13) with levels progressively decreasing during the course of treatment (FIG. 4A). Changes in serum cytokine levels correlated with changes in both HAQ and DAS28 scores (FIG. 4C). No MTX responsive patients achieved full remission.

Of note, levels of 5 cytokines that were upregulated in these patients prior to treatment remained unchanged during therapy despite clinical improvement (including: IL-1β, IL-5, IL-10, IL-12, MIP-1β) consistent with the conclusion that the incomplete response to MTX is driven, at least in part, by these known mediators of inflammation and joint erosions (FIG. 4B).

These data indicate that multiplex serum cytokine profiling identifies residual immune system activity in partially responsive patients, which represent the vast majority of RA patients receiving MTX treatment. This information is useful for rationally designing second-line combination therapies. Cytokine levels also correlated with disease indices in non-responsive patients (patients with minimal or no clinical improvements in their HAQ and DAS28 scores. (FIG. 4C)). In these patients, the majority of cytokine levels remained unchanged during treatment, with the exception of two: G-CSF, which progressively decreased, and MIP-1β, which progressively increased (FIG. 4A-B).

FIG. 4A shows changes in serum levels of cytokines that decreased following MTX treatment in both responders and nonresponders.

FIG. 4B shows cytokine levels that remained unchanged or increased following MTX treatment in both responders and nonresponders.

FIG. 4C shows efficacy measures of clinical response, HAQ and DAS28 scores, for both responders and nonresponders during MTX treatment.

### Example 5

### Potential of the CAI to Track Disease Activity and Therapeutic Response

Ninety CAI values obtained during 5 months of MTX treatment were determined on the cohort of 18 RA patients. The association between CAI and DAS28 values was assessed. CAI values were highly correlated to DAS28 (R=0.839). Associations between DAS28 and standard laboratory tests of disease activity (ESR and CRP) were also assessed. ESR and CRP values were only weakly correlated to DAS28 (R=0.21 and R=0.59 respectively). These data were validated on an independent cohort of 41 RA patients (correlation observed between CAI and DAS28 R=0.75). These data indicate that the CAI provides a more powerful means of quantitating therapeutic response than standard laboratory tests.

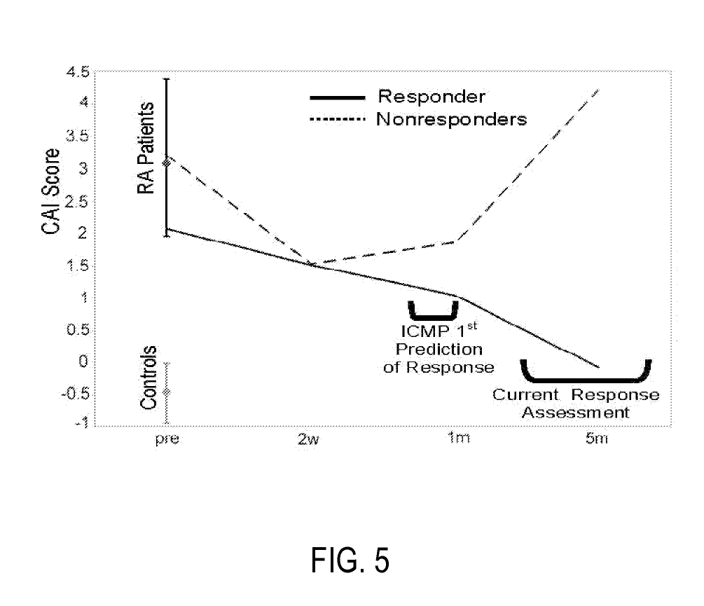

We have previously utilized the power of DFA's graphical output for monitoring therapeutic response and for developing prognostic predictive response criteria. Changes in CAI values for RA patients tracked over time and for healthy controls were plotted (FIG. 5). RA patients prior to treatment grouped into a distinct cluster that was well separated and statistically distinguished from CAI values of unaffected controls, indicating that cytokine profiles in early DMARD-naïve RA have discriminatory potential. Over time the CAI moved toward normalcy only in responsive patients (FIG. 5). Nonresponsive patient's CAI values remained predominantly within the range of untreated patients. Movement of responsive patients was clearly distinct from nonresponders early in the treatment course (FIG. 5).

These results indicate that changes in the CAI correlate with clinical response. Values obtained after only approximately 1 month of therapy are predictive of MTX response well before current clinical assessments of response (FIG. 5). These data indicate that use of the ICMP has the potential to shorten the time patients are receiving ineffective therapy.

FIG. 5 shows an application of the Cytokine Activity Index (CAI) in which CAI values decreased towards normalcy during treatment in responders, but remained principally in the range of patients prior to treatment in non-responders.

### Example 6

### Implications of Therapeutic Response Results in Regards to ICMP-Aided Therapeutic Use

In addition to its potential as a disease activity monitor, cytokines in the ICMP can be divided into mechanistic classes that can help guide therapy. Key mediators of joint erosions including: IL-1β, IL-6, IL-10, IL-17, and TNF-α are measured in this assay. These cytokines have known roles in joint damage including induction of matrixmetalloproteinases (MMPs), as well as chondrocyte and osteoclast activation. Inhibition of these cytokines in animal models and in human patients can limit joint destruction. Moreover, levels of these cytokines are associated with erosive disease. Finally, increased levels of these cytokines can be observed in serum in RA patients relative to controls. These cytokines are therefore are useful as biomarkers of erosive disease.

We found that levels of only a subset of erosive cytokines was decreased in MTX-responsive patients after therapy including: IL-6, IL-17, and TNF-α, and remained unchanged or increased in non-responsive patients, indicating that residual erosive activity remained even in MTX responsive patients (FIG. 5). Patients with persistent erosive cytokine levels despite MTX treatment are candidates for TNF-α-inhibitors as these drugs limit erosion in the majority of patients, demonstrating use of the invention for selecting a therapy on the basis of classification achieved using a predictive model.

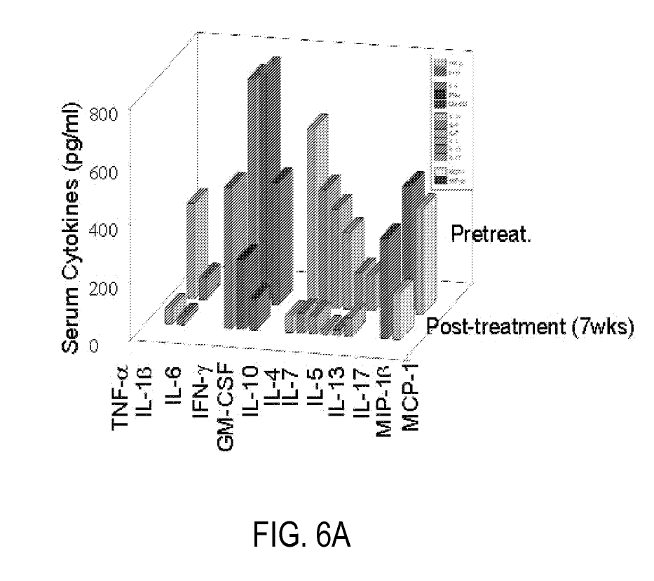

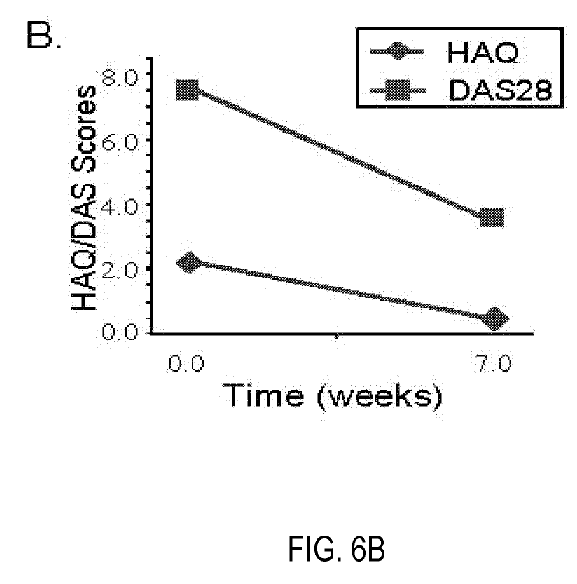

FIG. 6A shows averages of serum cytokine levels in patients prior to and after 7 months of therapy with TNF-α-inhibitor/MTX treatment. FIG. 6B shows efficacy measures of clinical response, HAQ and DAS28 scores, during TNF-α-inhibitor/MTX treatment.

In a preliminary analysis, serum cytokine levels were monitored in 2 RA patients with highly erosive disease treated with and responsive to Etanercept/MTX combination therapy. Serum cytokines were considered to be significantly decreased if values dropped by at least three standard deviations (>88.9% confidence limits) from baseline levels. Significant decreases were observed in 13 of 16 cytokines measured, demonstrating the powerful anti-rheumatic effects of this therapeutic regime (FIG. 6A). Etanercept/MTX combination therapy limits erosions in >90% of RA patients.

Of note, key cytokine mediators of erosions included in this assay, IL-1β, IL-6, IL-10, IL-17, and TNF-α were decreased significantly in these patients (FIG. 6A). Also, changes in serum cytokine levels trended with patient clinical assessments (HAQ and DAS scores (FIG. 6B).

### Example 7

### Use of the ICMP to Guide Biologic Therapy

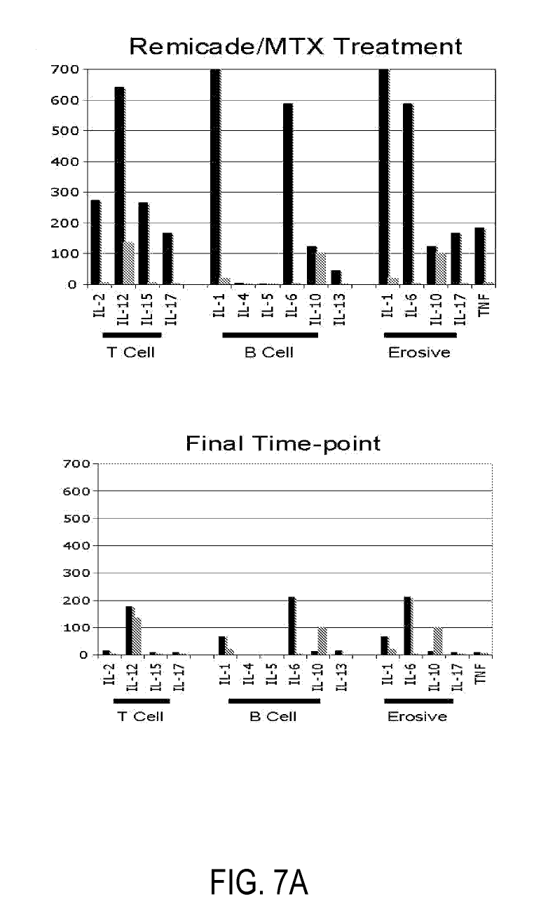

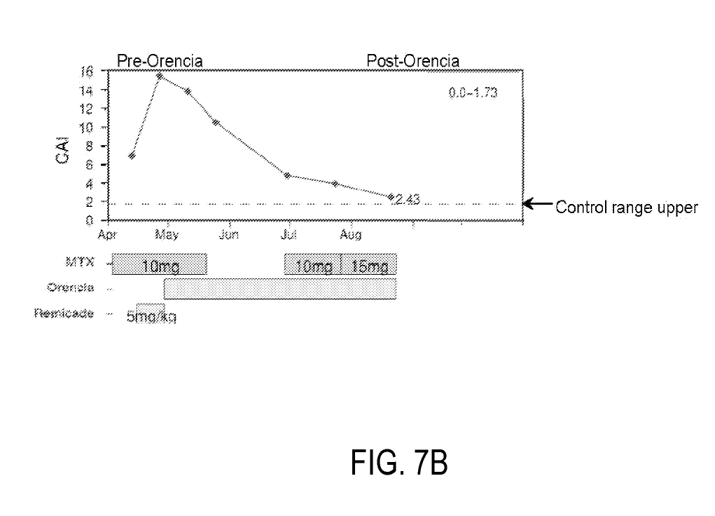

We measured serum cytokines in a highly active, erosive RA patient that had become non-responsive to infliximab/MTX treatment after 1 year of therapy. The CAI was highly elevated relative to unaffected control ranges as were individual erosive cytokines in this patient during the time observed undergoing infliximab/MTX treatment (FIG. 7A-B). Abatacept reduced disease activity, the patient's CAI, and erosive cytokines to nearly normal ranges after 4 months (FIG. 7A-B). Data are presented in a manner that could be used for reporting of ICMP data to a rheumatologist, layering changes in CAI over therapy and showing levels of individual cytokines grouped by known mechanisms to maximize the utility of a quantitative and mechanistic laboratory test.

FIG. 7A shows the tracking of disease activity changes with the ICMP by measuring the serum levels of T cell, B cell, and erosive cytokines in an RA patient with active (HAQ=3.8), erosive disease during infliximab/MTX treatment (black bars) relative to control ranges (grey bars).

FIG. 7B uses ICMP to show that CAI levels were highly elevated in the patient described in FIG. 7A relative to control ranges during infliximab/MTX treatment.

### Example 8

### Longitudinal Data Analysis and Modeling of RA Patients

Eighteen RA patients were followed for one year to monitor changes in cytokine levels. The average follow-up time was 98.6 days. The monitored cytokines included IL-1β, IL-2, IL-4, IL-5, IL-6, IL-7, IL-8, IL-10, IL-12, IL-13, Il-15, IL-17, TNF-α, IFN-α, IFN-γ, GM-CSF, MIP-1α, MIP-1β, IP-10, Eotaxin, MCP-1, and IL-1R antagonist. Table A shows aliases (names), accession numbers, and exemplary sequences as of Jul. 28, 2008 for the above cytokines Accession numbers shown in Table A correspond to sequences available in GenBank® and are available via the National Center for Biotechnology Information website maintained by the National Institutes of Health.

TABLE A

| | | Protein Ref. Sequence |
|---|---|---|
| | | (single-letter amino |
| Name (Synonyms) | Accession Numbers | acid abbreviations) |
| IL-1β (IL1B; 1L-1; IL-1B; | HGNC: 5992 | maevpelase mmayysgned |
| ILF2; catabolin; pro- | Entrez Gene: 3553 | dlffeadgpk qmkcsfqdld |
| interleukin-1-beta) | UniProt: P01584 | lcpldggiql risdhhyskg |
| | Ensemb1: | frqaasvvva mdklrkmlvp |
| | ENSG00000125538 | cpqtfqendl stffpfifee |
| | | epiffdtwdn eayvhdapvr |
| | | slnctlrdsq qkslvmsgpy |
| | | elkalhlqgq dmeqqvvfsm |
| | | sfvqgeesnd kipvalglke |
| | | knlylscvlk ddkptlqles |
| | | vdpknypkkk mekrfvfnki |
| | | einnklefes aqfpnwyist |
| | | sqaenmpvfl ggtkggqdit |
| | | dftmqfvss |
| | | (SEQ ID NO: 1) |
| IL-2 (Aldesleukin; IL2; | HGNC: 6001 | myrmqllsci alslalvtns |
| TCGF aldesleukin; | Entrez Gene: 3558 | aptssstkkt qlqlehllld |
| interleukin-2 lymphokine) | UniProt: P60568 | lqmilnginn yknpkltrml |
| | Ensemb1: | tfkfympkka telkhlqcle |
| | ENSG00000109471 | eelkpleevl nlaqsknfhl |
| | | rprdlisnin vivlelkgse |
| | | ttfmceyade tativeflnr |
| | | witfcqsiis tlt |
| | | (SEQ ID NO: 2) |
| IL-4 (IL4; BSF-1; BSF1; | HGNC: 6014 | mgltsqllpp lffllacagn |
| Binetrakin; MGC79402; | Entrez Gene: 3565 | fvhghkcdit lqeiiktlns |
| Pitrakinra) | UniProt: P05112 | lteqktlcte ltvtdifaas |
| | Ensemb1: | kntteketfc raatvlrqfy |
| | ENSG00000113520 | shhekdtrcl gataqqfhrh |
| | | kqlirflkrl drnlwglagl |
| | | nscpvkeanq stlenflerl |
| | | ktimrekysk css |
| | | (SEQ ID NO: 3) |
| IL-5 (IL5; EDF; TRF; | HGNC: 6016 | mrmllhlsll algaayvyai |
| interleukin-5) | Entrez Gene: 3567 | pteiptsalv ketlallsth |
| | UniProt: P051133 | rtllianetl ripvpvhknh |
| | Ensemb1: | qlcteeifqg igtlesqtvq |
| | ENSG00000113525 | ggtverlfkn lslikkyidg |
| | | qkkkcgeerr rvnqfldylq |
| | | eflgvmntew iies |
| | | (SEQ ID NO: 4) |
| IL-6 (IL6; BSF-2; BSF2; | HGNC: 6018 | mnsfstsafg pvafslglll |
| CDF; HGF) | Entrez Gene: 3569 | vlpaafpapv ppgedskdva |
| | UniProt: P05231 | aphrqpltss eridkqiryi |
| | Ensemb1: | ldgisalrke tcnksnmces |
| | ENSG00000136244 | skealaennl nlpkmaekdg |
| | | cfqsgfneet clvkiitgll |
| | | efevyleylq nrfesseeqa |
| | | ravqmstkvl iqflqkkakn |
| | | ldaittpdpt tnaslltklq |
| | | agnqwlqdmt thlilrsfke |
| | | flqsslralr qm |
| | | (SEQ ID NO: 5) |
| IL-7 (IL7) | HGNC: 6023 | mfhvsfryif glpplilvll |
| | Entrez Gene: 3574 | pvassdcdie gkdgkqyesv |
| | UniProt: P13232 | lmvsidqlld smkeigsncl |
| | Ensemb1: | nnefnffkrh icdankegmf |
| | ENSG00000104432 | lfraarklrq flkmnstgdf |
| | | dlhllkvseg ttillnctgq |
| | | vkgrkpaalg eaqptkslee |
| | | nkslkeqkkl ndlcflkrll |
| | | qeiktcwnki lmgtkeh |
| | | (SEQ ID NO: 6) |
| IL-8 (IL8; 3-10C; AMCF-I; | HGNC: 6025 | mtsklavall aaflisaalc |
| CXCL8; Emoctakin; GCP-1; | Entrez Gene: 3576 | egavlprsak elrcqcikty |
| GCP1; K60; LECT; LUCT; | UniProt: P10145 | skpfhpkfik elrviesgph |
| LYNAP; MDNCF; MONAP; | Ensemb1: | canteiivkl sdgrelcldp |
| NAF; NAP-1; NAP1; | ENSG00000169429 | kenwvqrvve kflkraens |
| SCYB8; TSG-1; b-ENAP; | | (SEQ ID NO: 7) |
| emoctakin 2) | | |
| IL-10 (IL10; CSIF; IL10A; | HGNC: 5962 | mhssallccl vlltgvrasp |
| MGC126450; MGC126451; | Entrez Gene: 3586 | gqgtqsensc thfpgnlpnm |
| TGIF) | UniProt: P22301 | lrdlrdafsr vktffqmkdq |
| | Ensemb1: | ldnlllkesl ledfkgylgc |
| | ENSG00000136634 | qalsemiqfy leevmpqaen |
| | | qdpdikahvn slgenlktlr |
| | | lrlrrchrfl pcenkskave |
| | | qvknafnklq ekgiykamse |
| | | fdifinyiea ymtmkirn |
| | | (SEQ ID NO: 8) |
| IL-12 (IL12B; IL-12B; | HGNC: 5970 | mchqqlvisw fslvflaspl |
| CLMF; CLMF2; NKSF; | Entrez Gene: 3593 | vaiwelkkdv yvveldwypd |
| NKSF2) | UniProt: P29460 | apgemvvltc dtpeedgitw |
| | Ensemb1: | tldqssevlg sgktltiqvk |
| | ENSG00000113302 | efgdagqytc hkggevlshs |
| | | llllhkkedg iwstdilkdq |
| | | kepknktflr ceaknysgrf |
| | | tcwwlttist dltfsvkssr |
| | | gssdpqgvtc gaatlsaerv |
| | | rgdnkeyeys vecqedsacp |
| | | aaeeslpiev mvdavhklky |
| | | enytssffir diikpdppkn |
| | | lqlkplknsr qvevsweypd |
| | | twstphsyfs ltfcvqvqgk |
| | | skrekkdrvf tdktsatvic |
| | | rknasisvra qdryysssws |
| | | ewasvpcs |
| | | (SEQ ID NO: 9) |
| IL-13 (IL13; ALRH; BHR1; | HGNC: 5973 | malllttvia ltclggfasp |
| MGC116786; MGC116788; | Entrez Gene: 3596 | gpvppstalr elieelvnit |
| MGC116789; NC30; P600) | UniProt: P35225 | qnqkaplcng smvwsinlta |
| | Ensemb1: | gmycaalesl invsgcsaie |
| | ENSG00000169194 | ktqrmlsgfc phkvsagqfs |
| | | slhvrdtkie vaqfvkdlll |
| | | hlkklfregr fn |
| | | (SEQ ID NO: 10) |
| IL-15 (IL15; MGC9721) | HGNC: 5977 | mriskphlrs isiqcylcll |
| | Entrez Gene: 3600 | lnshflteag ihvfilgcfs |
| | UniProt: P40933 | aglpkteanw vnvisdlkki |
| | Ensemb1: | edliqsmhid atlytesdvh |
| | ENSG00000164136 | psckvtamkc fllelqvisl |
| | | esgdasihdt venliilann |
| | | slssngnvte sgckeceele |
| | | eknikeflqs fvhivqmfin |
| | | is |
| | | (SEQ ID NO: 11) |
| IL-17 (IL17; CTLA-8; | HGNC: 5981 | mtpgktslvs lllllsleai |
| CTLA8; IL-17A) | Entrez Gene: 3605 | vkagitiprn pgcpnsedkn |
| | UniProt: Q16552 | fprtvmvnln ihnrntntnp |
| | Ensemb1: | krssdyynrs tspwnlhrne |
| | ENSG00000112115 | dperypsviw eakcrhlgci |
| | | nadgnvdyhm nsvpiqqeil |
| | | vlrrepphcp nsfrlekilv |
| | | svgctcvtpi vhhva |
| | | (SEQ ID NO: 12) |
| GM-CSF (CSF2; CSF; | HGNC: 2434 | mwlqsllllg tvacsisapa |
| GMCSF; MGC131935; | Entrez Gene: 1437 | rspspstqpw ehvnaiqear |
| MGC138897; Molgramostin; | UniProt: P04141 | rllnlsrdta aemnetvevi |
| Sargramostin; molgramostin; | Ensemb1: | semfdlqept clqtrlelyk |
| sargramostim) | ENSG00000164400 | qglrgsltkl kgpltmmash |
| | | ykqhcpptpe tscatqiitf |
| | | esfkenikdf llvipfdcwe |
| | | pvqe |
| | | (SEQ ID NO: 13) |
| MIP-1α (MAPKAP1; | HGNC: 18752 | mafldnptii lahirqshvt |
| MGC2745; MIP1; | Entrez Gene: 79109 | sddtgmcemv lidhdvdlek |
| OTTHUMP0000006420; | UniProt: Q9BPZ7 | ihppsmpgds gseiqgsnge |
| SIN1; SIN1b; SIN1g) | Ensemb1: | tqgyvyaqsv ditsswdfgi |
| | ENSG00000119487 | rrrsntaqrl erlrkerqnq |
| | | ikckniqwke rnskqsagel |
| | | kslfekkslk ekppisgkqs |
| | | ilsvrleqcp lqlnnpfney |
| | | skfdgkghvg ttatkkidvy |
| | | lplhssqdrl lpmtvvtmas |
| | | arvqdligli cwqytsegre |
| | | pklndnvsay clhiaeddge |
| | | vdtdfpplds nepihkfgfs |
| | | tlalvekyss pgltskeslf |
| | | vrinaahgfs liqvdntkvt |
| | | mkeillkavk rrkgsqkvsg |
| | | pqyrlekqse pnvavdldst |
| | | lesqsawefc lvrenssrad |
| | | gvfeedsqid iatvqdmlss |
| | | hhyksfkvsm ihrlrfttdv |
| | | qlgisgdkve idpvtnqkas |
| | | tkfwikqkpi sidsdllcac |
| | | dlaeekspsh aifkltylsn |
| | | hdykhlyfes daatvneivl |
| | | kvnyilesra staradyfaq |
| | | kgrklnrrts fsfqkekksg |
| | | qq |
| | | (SEQ ID NO: 14) |
| MIP-1β (CCL4; ACT-2; | HGNC: 10630 | mklcvtvlsl lmlvaafcsp |
| ACT; AT744.1; Act-2; | Entrez Gene: 6351 | alsapmgsdp ptaccfsyta |
| CCL4L; G-26; HC21; LAG- | UniProt: P13236 | rklprnfvvd yyetsslcsq |
| 1; LAG1; MGC104418; | Ensemb1: | pavvfqtkrs kqvcadpses |
| MGC126025; MGC126026; | ENSG00000129277 | wvqeyvydle ln |
| MIP-1-beta 1; MIP1B; | | (SEQ ID NO: 15) |
| SCYA2; SCYA4; SCYA4L; | | |
| SIS-gamma 3) | | |
| IP-10 (CSCL10; C7; Gamma- | HGNC: 10637 | mnqtailicc lifltlsgiq |
| IP10; IFI10; INP10; | Entrez Gene: 3627 | gvplsrtvrc tcisisnqpv |
| SCYB10; crg-2; gIP-10; mob- | UniProt: P02778 | nprsleklei ipasqfcpry |
| 1) | Ensemb1: | eiiatmkkkg ekrclnpesk |
| | ENSG00000169245 | aiknllkays kerskrsp |
| | | (SEQ ID NO: 16) |
| Eotaxin (CCL11; | HGNC: 10610 | mkvsaallwl lliaaafspq |
| MGC22554; SCYA11) | Entrez Gene: 6356 | glagpasvpt tccfnlanrk |
| | UniProt: P51671 | iplqrlesyr ritsgkcpqk |
| | Ensemb1: | avifktklak dicadpkkkw |
| | ENSG00000172156 | vqdsmkyldq ksptpkp |
| | | (SEQ ID NO: 17) |
| MCP-1 (CCL2; GDCF-2; | HGNC: 10618 | mkvsaallcl lliaatfipq |
| HC11; HSMCR30; MCAF; | Entrez Gene: 6347 | glaqpdaina pvtccynftn |
| MCP1; MGC9434; SCYA2; | UniProt: P13500 | rkisvqrlas yrritsskcp |
| SMC-CF) | Ensemb1: | keavifktiv akeicadpkq |
| | ENSG00000108691 | kwvqdsmdhl dkqtqtpkt |
| | | (SEQ ID NO: 18) |
| IFN-γ (IFNG; IFG; IFI) | HGNC: 5438 | mkytsyilaf qlcivlgslg |
| | Entrez Gene: 3458 | cycqdpyvke aenlkkyfna |
| | UniProt: P01579 | ghsdvadngt lflgilknwk |
| | Ensemb1: | eesdrkimqs qivsfyfklf |
| | ENSG00000111537 | knfkddqsiq ksvetikedm |
| | | nvkffnsnkk krddfekltn |
| | | ysvtdlnvqr kaiheliqvm |
| | | aelspaaktg krkrsqmlfr |
| | | grrasq |
| | | (SEQ ID NO: 19) |
| IFN-α (IFNA2; IFNA; | HGNC: 5423 | maltfallva llvlsckssc |
| INFA2; MGC125764; | Entrez Gene: 3440 | svgcdlpqth slgsrrtlml |
| MGC125765) | UniProt: P01563 | laqmrkislf sclkdrhdfg |
| | Ensemb1: | fpqeefgnqf qkaetipvlh |
| | ENSG00000188379 | emiqqifnlf stkdssaawd |
| | | etlldkfyte lyqqlndlea |
| | | cviqgvgvte tplmkedsil |
| | | avrkyfqrit lylkekkysp |
| | | cawevvraei mrsfslstnl |
| | | qeslrske |
| | | (SEQ ID NO: 20) |
| TNF-α (TNF; Cachectin; | HGNC: 11892 | mstesmirdv elaeealpkk |
| DIF; | Entrez Gene: 7124 | tggpqgsrrc lflslfsfli |
| OTTHUMP00000037669; | UniProt: P01375 | vagattlfcl lhfgvigpqr |
| TNF-a; TNFA; TNFSF2; | Ensemb1: | eefprdlsli splaqavrss |
| cachectin) | ENSG00000204490 | srtpsdkpva hvvanpqaeg |
| | | qlqwlnrran allangvelr |
| | | dnqlvvpseg lyliysqvlf |
| | | kgqgcpsthv llthtisria |
| | | vsyqtkvnll saikspcqre |
| | | tpegaeakpw yepiylggvf |
| | | qlekgdrlsa einrpdyldf |
| | | aesgqvyfgi ial |
| | | (SEQ ID NO: 21) |
| IL-1 receptor | HGNC: 6000 | meicrglrsh |
| antagonist (Anakinra; ICIL- | Entrez Gene: 3557 | litlllflfh seticrpsgr |
| 1RA; IL-1RN; IL-lra; IL- | UniProt: P18510 | ksskmqafri wdvnqktfyl |
| 1ra3; IL1F3; IL1RA; IRAP; | Ensemb1: | rnnqlvagyl |
| MGC10430) | ENSG00000136689 | qgpnvnleek |
| | | idvvpiepha lflgihggkm |
| | | clscvksgde trlqleavni |
| | | tdlsenrkqd |
| | | krfafirsds |
| | | gpttsfesaa cpgwflctam |
| | | eadqpvsltn mpdegvmvtk |
| | | fyfqede |
| | | (SEQ ID NO: 22) |

Data were modeled using Hierarchical Linear Mixed Models to account for repeated cytokine measurements within individuals. In all models a heterogeneous first order auto-regressive covariance structure was imposed, although any suitable covariance structure would give relevant results. The data were modeled using univariate analysis with DAS28, VAS Overall, VAS fatigue, VAS pain, and VAS sleep as shown in Tables 1-4. The data were also modeled using multivariate analysis as shown in Table 5.

Table 1 represents a univariate analysis of each cytokine to DAS28 when controlling for a time effect.

TABLE 1

| Cytokine | Nominal P Value |
|---|---|
| IL-1β, | 0.0183 |
| IL-2 | 0.0359 |
| IL-4 | 0.0073 |
| IL-5 | 0.0212 |
| IL-6 | 0.0001 |
| IL-7 | 0.0006 |
| IL-8 | 0.4444 |
| IL-10 | 0.0007 |
| IL-12 | 0.0037 |
| IL-13 | 0.0019 |
| IL-15 | 0.0280 |
| IL-17 | 0.0001 |
| TNF-α | 0.0402 |
| IFN-α | 0.0002 |
| IFN-γ | 0.8048 |
| GM-CSF | 0.0001 |
| MIP-1α | 0.0453 |
| MIP-1β | 0.0870 |
| IP-10 | 0.0019 |
| Eotaxin | 0.8945 |
| MCP-1 | 0.3516 |
| IL-1 RA | 0.0502 |

Table 2 represents a univariate analysis of each cytokine to VAS Overall when controlling for a time effect.

TABLE 2

| Cytokine | Nominal P Value |
|---|---|
| IL-1β, | 0.0174 |
| IL-2 | 0.0234 |
| IL-4 | 0.0033 |
| IL-5 | 0.0067 |
| IL-6 | 0.0001 |
| IL-7 | 0.0011 |
| IL-8 | 0.2429 |
| IL-10 | 0.0001 |
| IL-12 | 0.1444 |
| IL-13 | 0.0001 |
| IL-15 | 0.0056 |
| IL-17 | 0.0001 |
| TNF-α | 0.0034 |
| IFN-α | 0.0001 |
| IFN-γ | 0.3115 |
| GM-CSF | 0.0001 |
| MIP-1α | 0.0101 |
| MIP-1β | 0.0026 |
| IP-10 | 0.0034 |
| Eotaxin | 0.5331 |
| MCP-1 | 0.5687 |
| IL-1 RA | 0.0164 |

Table 3 represents a univariate analysis of each cytokine to VAS fatigue when controlling for a time effect.

TABLE 3

| Cytokine | Nominal P Value |
|---|---|
| IL-1β, | 0.1952 |
| IL-2 | 0.0241 |
| IL-4 | 0.0068 |
| IL-5 | 0.0194 |
| IL-6 | 0.0012 |
| IL-7 | 0.0836 |
| IL-8 | 0.2780 |
| IL-10 | 0.0048 |
| IL-12 | 0.1241 |
| IL-13 | 0.0069 |
| IL-15 | 0.0613 |
| IL-17 | 0.0005 |
| TNF-α | 0.0111 |
| IFN-α | 0.0003 |
| IFN-γ | 0.5763 |
| GM-CSF | 0.0005 |
| MIP-1α | 0.0079 |
| MIP-1β | 0.0549 |
| IP-10 | 0.0027 |
| Eotaxin | 0.9700 |
| MCP-1 | 0.6839 |
| IL-1 RA | 0.1550 |

Table 4 represents a univariate analysis of each cytokine to VAS sleep when controlling for a time effect.

TABLE 4

| Cytokine | Nominal P Value |
|---|---|
| IL-1β, | 0.0121 |
| IL-2 | 0.0122 |
| IL-4 | 0.0003 |
| IL-5 | 0.0098 |
| IL-6 | 0.0001 |
| IL-7 | 0.0024 |
| IL-8 | 0.7078 |
| IL-10 | 0.0019 |
| IL-12 | 0.0179 |
| IL-13 | 0.0096 |
| IL-15 | 0.0093 |
| IL-17 | 0.0003 |
| TNF-α | 0.0226 |
| IFN-α | 0.0002 |
| IFN-γ | 0.0765 |
| GM-CSF | 0.0001 |
| MIP-1α | 0.0001 |
| MIP-1β | 0.0006 |
| IP-10 | 0.0760 |
| Eotaxin | 0.2430 |
| MCP-1 | 0.0386 |
| IL-1 RA | 0.0002 |

Table 5 shows the multivariate models that associate with a given clinical outcome when controlling for a time effect. For example, the combination of IL-6 and IP-10 are associated with DAS28 through the equation: DAS28=3.5422+0.2704(IL-6 concentration)+0.1057(IP-10 concentration).

TABLE 5

| Terms | Beta | P |
|---|---|---|
| DAS 28 Model | | |
| Intercept | 3.5442 | <0.0001 |
| IL-6 | 0.2704 | <0.0001 |
| IP-10 | 0.1057 | 0.0327 |
| VAS Overall Model | | |
| Intercept | 1.2282 | 0.1183 |
| IL-6 | 0.2544 | 0.0080 |
| IFN-α | 0.6091 | 0.0057 |
| VAS Fatigue Model | | |
| Intercept | 1.4355 | 0.0774 |
| IFN-α | 0.6688 | 0.0007 |
| IP-10 | 0.2108 | 0.0063 |
| VAS Pain | | |
| Intercept | 2.5023 | <0.0001 |
| IL-6 | 0.4157 | <0.0001 |
| MIP-1α | 0.2369 | 0.0091 |
| VAS Sleep | | |
| Intercept | 2.4555 | 0.0002 |
| IL-4 | 0.3153 | 0.0234 |
| MIP-1α | 0.2217 | 0.0136 |
| IP-10 | 0.1957 | 0.0168 |

### Example 9

### Area Under Curve (AuC) Analysis of RA Patients and Controls

In total, 22 cytokines and chemokines were evaluated for their ability to discriminate RA patients from healthy controls. The data consisted of 115 RA patients and 118 healthy controls. In all models a p value less than 0.05 was considered statistically significant. The models used for the discrimination included: Logistical Regression, Principal Component Analysis (PCA), Classification and Regression Trees (CART), and Meta Learners including Boosted CART and Random Forests™. Predictive accuracy was assessed using a Receiver Operating Characteristic (ROC) Curve, which is a graphical plot of sensitivity versus specificity. The ROC curve describes the predictive ability of a clinical test by estimating the Area under the ROC curve (AuC). AuC values range from 1.0 (perfect classification) to 0.5 (random classification), below 0.5 is less than random. Table 6 shows univariate predictive ability for the 22 markers as measured by the AuC value.

TABLE 6

| Marker | AuC |
|---|---|
| IFN-α | 0.88 |
| IL-1β | 0.80 |
| IL-6 | 0.80 |
| IL-1 RA | 0.80 |
| IL-2 | 0.78 |
| IL-7 | 0.78 |
| IL-15 | 0.78 |
| TNF-α | 0.78 |
| IL-10 | 0.76 |
| MIP-1α | 0.76 |
| IL-17 | 0.75 |
| IP-10 | 0.75 |
| IL-13 | 0.73 |
| MIP-1β | 0.73 |
| IL-4 | 0.72 |
| IL-12 | 0.72 |
| GM-CSF | 0.69 |
| IL-5 | 0.65 |
| IFN-γ | 0.62 |
| MCP-1 | 0.62 |
| Eotaxin | 0.53 |
| IL-8 | 0.38 |

### Single Substitution

The following markers can be substituted in for any other variable in the model: IL-1β, IL-2, IL-4, IL-5, IL-6, IL-7, IL-8, IL-10, IL-12, IL-13, IL-15, IL-17, TNF-α, IFN-α, GM-CSF, MIP-1α, MIP-1β, IP10, Eotaxin, MCP-1, IL-1 RA (receptor antagonist). Note that the performance of the model is not materially affected by the substitution of one highly-correlated marker for another. Markers for which “expression is highly correlated,” as used herein, refers to expression values that have a degree of correlation sufficient for interchangeable use of the expression values/markers in a predictive model for inflammatory disease. For example, if a predictive model uses marker “x” with expression value “X,” marker “y” having expression value “Y” is highly correlated if it can be substituted into the predictive model in a readily apparent, straightforward way to one of ordinary skill in the art having the benefit of this disclosure. For example, using a linear transformation, and assuming a relationship between the expression values of markers x and y that is approximately linear (i.e., such that a standard slope-intercept form applies to the relationship, e.g., Y=a+bX, in this example), then X can be substituted into the predictive model. In other embodiments, other transformations may be used as known to one of skill in the art.

Scaling, according to various methods, is well within the level of one of ordinary skill in the art. For example, one method is based on multiplying control sample expression values by a factor selected such that the control sample values are scaled to match the mean expression values for the controls used to construct the models. Some examples follow.

Cytokine A can be transformed into cytokine B through a polynomial fitting to the data. All polynomials can be expressed in the general form:

$$Cytokine A = {\sum }_{0}^{n} {w}_{i} * {( Cytokine B )}^{n}$$

where n is the degree of the polynomial. If the transformation was fit with a one degree polynomial the resulting model would be linear of the form Cytokine A=Weight0+Weight1*Cytokine B. For example, if IL1 Beta was cytokine A and IL-2 was cytokine B then the transform would be the following: IL-1β=0.996+0.951*IL-2.

If the transformation was fit to a two degree polynomial then the fit would be a quadratic equation of the form Cytokine A=Weight0+Weight1*Cytokine B+Weight2*Cytokine B². For example, if IL-6 was Cytokine A and IL-15 was Cytokine B then the transformation would be the following: IL-6=1.968+0.3795*IL-15+0.0378*IL-15².

In addition, some of the markers could be grouped into “power groups” based on their relatedness to the other group members. Table 7 shows markers with correlations between R>0.4 and R>0.9 broken down in 0.10 increments. Here, R is equivalent to ρ, the Pearson product-moment correlation coefficient, or just “correlation coefficient” herein.

TABLE 7

| | Correlation | | | | | |
|---|---|---|---|---|---|---|
| | R > 0.4 | R > 0.5 | R > 0.6 | R > 0.7 | R > 0.8 | R > 0.9 |
| Markers | IL-1β | IL-1β | IL-1β | IL-1β | IL-1β | IL-1β |
| | IL-2 | IL-2 | IL-2 | IL-2 | IL-2 | IL-2 |
| | IL-4 | IL-4 | IL-4 | IL-5 | IL-15 | IL-15 |
| | IL-5 | IL-5 | IL-6 | IL-6 | MIP-1β | |
| | IL-6 | IL-6 | IL-7 | IL-7 | IL-1 | |
| | IL-7 | IL-7 | IL-10 | IL-15 | RA | |
| | IL-10 | IL-10 | IL-12 | IL-17 | | |
| | IL-12 | IL-12 | IL-13 | TNF-α | | |
| | IL-13 | IL-13 | IL-15 | IFN-α | | |
| | IL-15 | IL-15 | IL-17 | MIP-1α | | |
| | IL-17 | IL-17 | TNF-α | MIP-1β | | |
| | TNF-α | TNF-α | IFN-α | IL-1 | | |
| | IFN-α | IFN-α | GM-CSF | RA | | |
| | GM-CSF | GM-CSF | MIP-1α | | | |
| | MIP-1α | MIP-1α | MIP-1β | | | |
| | MIP-1β | MIP-1β | IL-1 RA | | | |
| | IL-1 RA | IL-1 RA | | | | |

### Logistical Regression

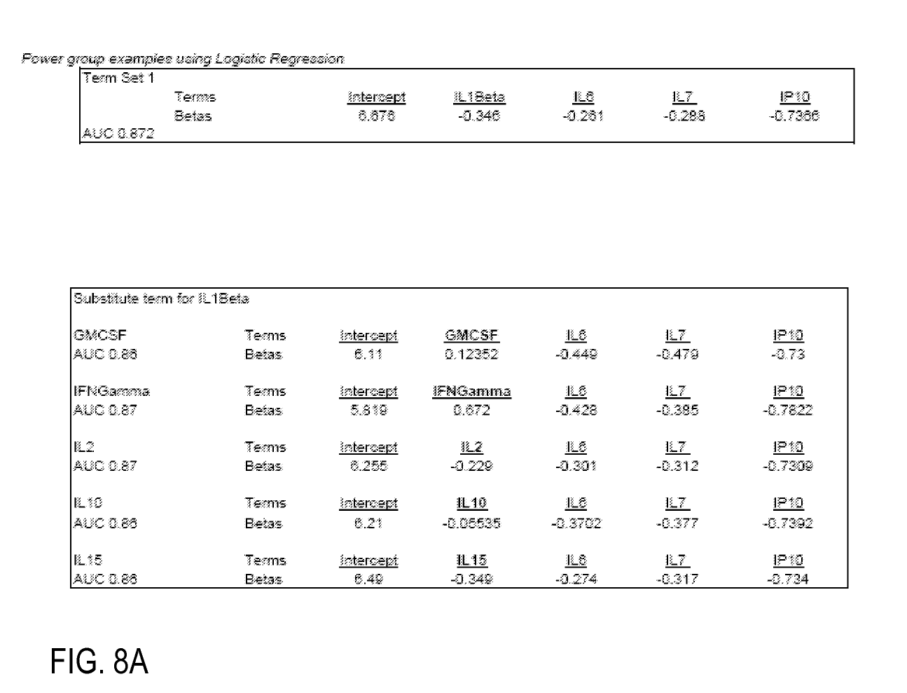

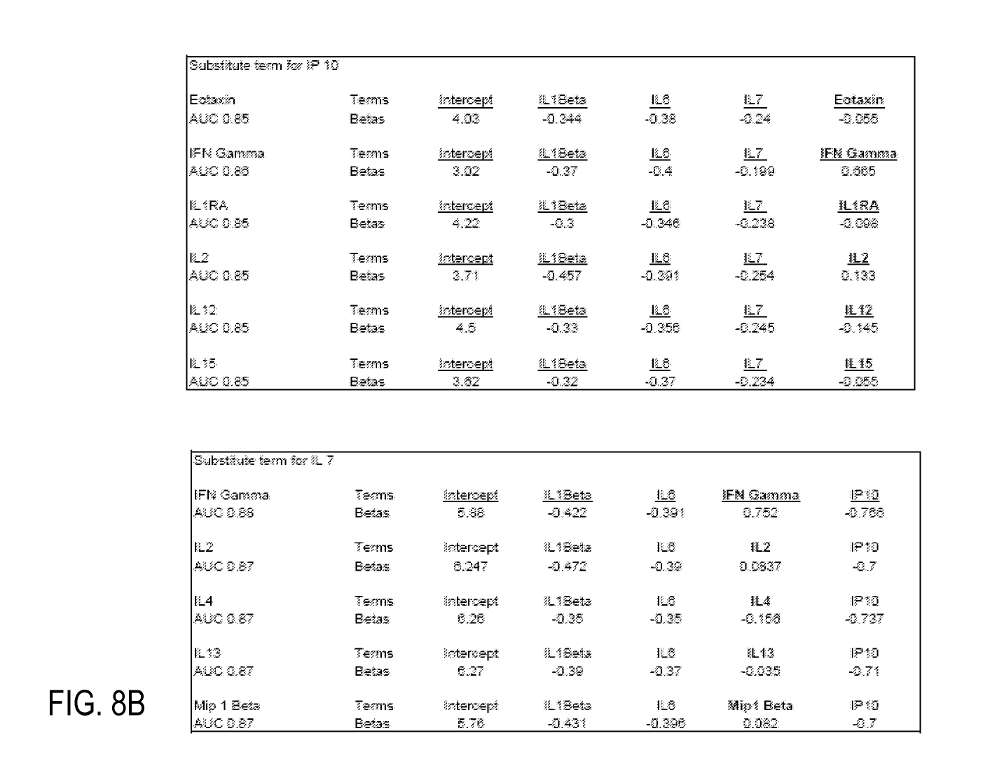

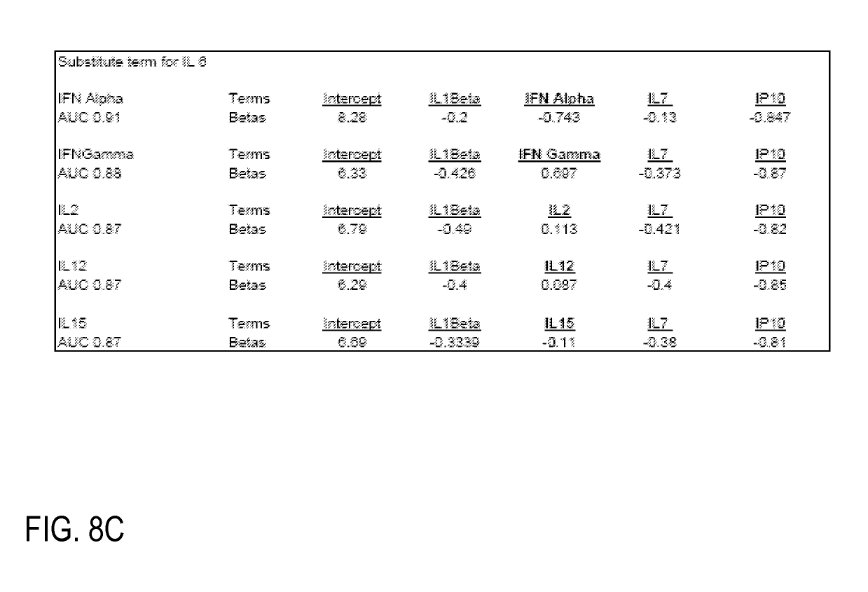

Logistical Regression (Agresti, A., “Categorical Data Analysis,” 2nd ed., New York: Wiley-Interscience, 2002.) was performed on several combinations of variables. Using 19 cytokines (IL-1β, IL-2, IL-4, IL-5, IL-6, IL-7, IL-8, IL-10, IL-12, IL-13, IL-15, IL-17, GM-CSF, MIP-1α, MIP-1β, IP10, Eotaxin, MCP-1, IL-1 receptor antagonist) produced an excellent model with an ROC AuC of 0.899. By selecting the best 4 variables from this group (IL-1β, IL-6, IL-7, IP-10) an AuC of 0.872 was obtained. Finally 2 models with 3 cytokines each produced AuCs ranging from 0.711 to 0.605 (IL-5, IFN-γ, MCP-1; IL-8, Eotaxin, MCP-1). FIGS. 8A-C include tables showing 21 examples of different terms (and their corresponding beta coefficients, or weights) that were substituted into a logistic regression equation in a manner that maintains predictive accuracy. FIG. 8A shows the original term set, including AuC value, intercept value, and beta parameters for the four markers used (IL-1β, IL-6, IL-7, IP-10) (top box), and substitution of GM-CSF, IFN-γ, IL-2, IL-10, and IL-15 for IL-1β (bottom box). FIG. 8B shows substitution of Eotaxin, IFN-γ, IL-1 RA, IL-2, IL-12, and IL-15 for IP-10 (top box), and substitution of IFN-γ, IL-2, IL-4, IL-13, and MIP-1β for IL-7 (bottom box). FIG. 8C shows substitution of IFN-α, IFN-γ, IL-2, IL-12, and IL-15 for IL-6. Scores are determined according to one embodiment by multiplying expression values for each of the markers by the respective weights (beta coefficients) for the markers and adding the intercepts. Scores at or above a predetermined threshold represent one class, whereas scores below the threshold represent a second class—e.g., the threshold may be zero and the classes may be disease (≧0) and normal (<0). “Normal” may correspond to no disease, mild disease, or intermediate disease. As will be apparent to one of ordinary skill in the art, the threshold value of 0 is not limiting, and other threshold values may be used. In some instances, it may be necessary to scale expression data prior to using the expression values with the provided exemplary model coefficients.

### Principal Component Analysis

Principal Component Analysis (PCA) is a dimension reduction technique that uncorrelates a set of variables (Cooley, W. W. and Lohnes, P. R., “Multivariate procedures for the behavioral science,” New York: John Wiley & Sons, Inc., 1962; Jackson, E. J. “A User's Guide to Principal Components,” New York: John Wiley & Sons, Inc., 2003.). Here a PCA was used with a Vari-max rotation to place as much variability as possible on the first component. Eigenvalues greater than 0.85 were retained for further analysis. Using 19 cytokines (IL-1β, IL-2, IL-4, IL-5, IL-6, IL-7, IL-8, IL-10, IL-12, IL-13, IL-15, IL-17, GM-CSF, MIP-1α, MIP-1β, IP-10, Eotaxin, MCP-1, IL-1 RA (receptor antagonist)) produced an excellent model with an AuC of 0.846. Reducing the number of cytokines to 9 (IL-5, IL-8, IL-10, IL-12, IL-13, GM-CSF, IP-10, Eotaxin, MCP-1) produced a model with an AuC of 0.805. Further reducing the number of cytokines to 5 (IL-8, IL-13, IP-10, Eotaxin, MCP-1) produced a model with an AuC of 0.788.

### Classification and Regression Trees

Classification and Regression Trees (CART) classify samples through a series of if/then decisions denoted “leaves” (Breiman, L., Friedman, J. H., Olshen, R. A. and Stone, C. J. “Classification and Regression Trees,” Wadsworth, 1983.). When several leaves are combined, a classification “tree” is created. All CARTs were created in Statistica v.7 (Tulsa, Okla.) and were 5 fold cross validated. When 22 cytokines were presented to the CART algorithm 9 cytokines were selected (IL-1β, IL-8, IL-2, IL-4, IL-12, IL-1 receptor antagonist, MCP-1, IP-10, TNF-α) to function as leaves. This model had an AuC of 0.982. When only 6 cytokines (IFN-α, IL-5, IL-6, IL-10, IFN-γ, GM-CSF) were presented to the CART algorithm the resulting AuC was 0.972. Finally, only 3 cytokines (IL-8, Eotaxin, MCP-1) were given to the CART algorithm and the resulting AuC was 0.956.

### Meta Learners

Meta Learners are algorithms that take several “weak” learners such as logistic regression, CART, and linear regression and combine them to improve classification accuracy. We tried 2 popular Meta Learners: boosted CART and Random Forests™. To protect against over-fitting, a separate training and test set were used. Statistica v. 7 was used to perform the meta-learner analyses.

### Boosted CART

Boosted CART is an iteratively reweighed classification scheme (Freund, Y. and Schapire, R. E., “A decision-theoretic generalization of on-line learning and an application to boosting,” Journal of Computer and System Sciences, 55(1):119-139, 1997.). Samples that are hardest to classify are given the most weight and those easiest to classify given the smallest. Using 22 cytokines (IL-1β, IL-2, IL-4, IL-5, IL-6, IL-7, IL-8, IL-10, IL-12, IL-13, IL-15, IL-17, GM-CSF, MIP-1α, MIP-1β, IP-10, Eotaxin, MCP-1, IFN-γ, IFN-α, TNF-α, IL-1 receptor antagonist) produced a training AuC of 0.991 and a test AuC of 0.932. Appendix A shows uncompiled C code of the beta parameters required to achieve the results for this 22-cytokine boosted CART model. When only 3 cytokines (IL-8, Eotaxin, MCP-1) were used the training AuC was 0.839 and the test AuC was 0.829. Appendix B shows uncompiled C code of the beta parameters required to achieve the results for this 3-cytokine boosted CART model.

### Random Forests™

Random Forests™ are based upon the idea of creating hundreds of CARTs (Breiman, L. “Random Forests,” Machine Learning, 45 (1), 5-32, 2001.). The variables selected for each “leaf” and the numerical value that splits two or more classes is based upon a pseudo-random number generator. Each CART is created with a uniform number of leaves and when all the trees are created, a majority vote based algorithm generates final classification calls. Using all 22 cytokines (IL-1β, IL-2, IL-4, IL-5, IL-6, IL-7, IL-8, IL-10, IL-12, IL-13, IL-15, IL-17, GM-CSF, MIP-1α, MIP-1β, IP-10, Eotaxin, MCP-1, IFN-γ, IFN-α, TNF-α, IL-1 receptor antagonist) produced a random forest with a training AuC of 0.961 and a test AuC of 0.906. Appendix C shows uncompiled C code of the beta parameters required to achieve the results for this 22-cytokine Random Forest model.

Reducing the number of cytokines to 5 (IL-4, IL-10, IL-12, IL-17, IP-10) produced a training AuC of 0.934 and a test AuC of 0.800. Appendix D shows uncompiled C code of the beta parameters required to achieve the results for this 5-cytokine Random Forest model. When only 3 cytokines (IL-8, Eotaxin, MCP-1) were given to the algorithm a training AuC of 0.888 and a test AuC of 0.730 was produced. Appendix E shows uncompiled C code of the beta parameters required to achieve the results for this 3-cytokine Random Forest model.

### Example 10

### Support Vector Machines Modeling of RA Patients and Healthy Controls

105 RA patients and 128 healthy controls were modeled through Support Vector Machines (SVM). The goal of the SVM model was to classify individuals into either the RA or Healthy Control category. The data were first split 75%/25% Training/Test to allow model performance to be evaluated. The SVM was fit using a Radial Bias Function kernel (gamma=0.333) combined with 5-fold cross validation. The model performed similar to the other methods utilized in this application (Table 8).

Table 8 represents SVM modeling of RA patients and healthy controls for categorization.

TABLE 8

| Training Set | | Test Set | |
|---|---|---|---|
| RA | 74 | RA | 31 |
| Controls | 100 | Controls | 28 |

| | | | Accuracy |
|---|---|---|---|
| Model Terms | IL-1β | Train | 80% |
| | IL-6 | | |
| | IL-7 | | |
| | IP-10 | | |
| | IL-1β | Test | 80% |
| | IL-6 | | |
| | IL-7 | | |
| | IP-10 | | |
| | IL-8 | Train | 68% |
| | IL-13 | | |
| | IP-10 | | |
| | Eotaxin | | |
| | MCP-1 | | |
| | IL-8 | Test | 85% |
| | IL-13 | | |
| | IP-10 | | |
| | Eotaxin | | |
| | MCP-1 | | |
| | IL-8 | Train | 63% |
| | Eotaxin | | |
| | MCP-1 | | |
| | IL-8 | Test | 52% |
| | Eotaxin | | |
| | MCP-1 | | |

While the invention has been particularly shown and described with reference to a preferred embodiment and various alternate embodiments, it will be understood by persons skilled in the relevant art that various changes in form and details can be made therein without departing from the spirit and scope of the invention.

All publications, including scientific publications, references to gene sequences (including without limitation, references to accession numbers and gene names), issued patents, patent publications, and the like are hereby incorporated by reference in their entirety for all purposes.

1. A method of scoring a sample acquired from a mammalian subject, comprising:
obtaining a dataset comprising quantitative data associated with dataset members IL-4, IL-6, IL-8, IL-13, MCP-1, and TNF-α, wherein the data comprise measured values obtained from the sample;
analyzing the dataset against a cytokine profile dataset to produce a first score for the sample; and
outputting the first score.

2. The method of claim 1, wherein the analyzing step comprises use of a predictive model.

3. The method of claim 2, wherein the predictive model is developed using at least one process selected from the group consisting of logistic regression, discriminate function analysis (DFA), classification and regression tree (CART), principal component analysis (PCA), Meta Learners, Boosted CART, Random Forests, support vector machines (SVM), and bootstrap aggregating (bagging).

4. The method of claim 2, further comprising predicting a quantitative clinical datapoint selected from the group consisting of DAS, DAS 28, HAQ, mHAQ, MDHAQ, physician global assessment VAS, patient global assessment VAS, Overall VAS, sleep VAS, pain VAS, fatigue VAS, SDAI, CDAI, ACR20, ACR50, ACR70, sharp score, van der Heijde modified sharp score, mTSS, and Larson score.

5. The method of claim 2, further comprising categorizing the sample according to the predictive model, wherein the categorization is selected from the group consisting of a rheumatoid arthritic disease categorization, a healthy categorization, a therapy-responsive categorization, and a therapy non-responsive categorization.

6. The method of claim 5, wherein a probability that the categorization is correct is at least 60%.

7. The method of claim 6, wherein the probability that the categorization is correct is at least 70%.

8. The method of claim 7, wherein the probability that the categorization is correct is at least 80%.

9. The method of claim 8, wherein the probability that the categorization is correct is at least 90%.

10. The method of claim 1, further comprising selecting a therapeutic regimen based on the score.

11. The method of claim 1, further comprising comparing the score to a second score determined for a second sample obtained from the mammalian subject.

12. The method of claim 11, wherein a change between the first score and the second score indicates a response to treatment.

13. The method of claim 11, wherein a change between the first score and the second score indicates a change in disease activity.

14. The method of claim 1, wherein the quantitative data associated with at least one dataset member is determined by substitution of quantitative data corresponding to a marker known to have expression highly correlated with the at least one dataset member.

15. The method of claim 14, wherein a correlation coefficient is greater than 0.5 for the at least one dataset member and the marker known to have expression highly correlated with the at least one dataset member.

16. The method of claim 15, wherein the correlation coefficient is greater than 0.7.

17. The method of claim 16, wherein the correlation coefficient is greater than 0.9.

18. The method of claim 1, wherein the dataset further comprises quantitative data associated with IL-1β.

19. The method of claim 1, wherein the dataset further comprises quantitative data associated with IL-1β, IL-2, IL-12, IL-15, IL-17, IL-5, and IL-10.

20. The method of claim 1, wherein the dataset further comprises quantitative data associated with IL-1β, IL-2, IL-12, GM-CSF, G-CSF, IL-7, IL-17, IL-5, IL-10, IL-13, and MIP-1β.

21. The method of claim 1, wherein the dataset further comprises quantitative data associated with MIP-1β, G-CSF, IL-17, IL-12, IL-7, GM-CSF, IL-1β, IL-2, IL-5, and IL-10.

22. The method of claim 1, wherein the dataset further comprises quantitative data associated with IL-2, GM-CSF, IL-7, IL-17, and G-CSF.

23. The method of claim 1, wherein the dataset further comprises quantitative data associated with IL-12, IL-1β, IL-10, IL-5, MIP-1β, IL-2, GM-CSF, IL-7, and IL-17.

24. The method of claim 1, wherein the dataset further comprises quantitative data associated with IL-1β, IL-2, IL-5, IL-7, IL-10, IL-12, IL-15, IL-17, IFN-α, IFN-γ, GM-CSF, MIP-1α, MIP-1β, IP-10, Eotaxin, and IL-1 receptor antagonist.

25. The method of claim 1, wherein the values are measured using a process that comprises a protein binding step.

26. The method of claim 25, wherein the protein comprises an antibody.
